(19) United States
(12) Patent Application Publication
(10) Pub. No.: US 2014/0327753 A1
(43) Pub. Date: Nov. 6, 2014

(54) APPARATUS AND METHOD FOR POSITIONING AN IRIS FOR IRIS IMAGE CAPTURE

(71) Applicant: Delta ID Inc., Fremont, CA (US)

(72) Inventor: Salil Prabhakar, Fremont, CA (US)

(73) Assignee: Delta ID Inc., Fremont, CA (US)

(21) Appl. No.: 14/055,697

(22) Filed: Oct. 16, 2013

Related U.S. Application Data
(60) Provisional application No. 61/819,931, filed on May 6, 2013.

(51) Int. Cl. G06K 9/00

(52) U.S. Cl. CPC G06K 9/00604
USPC 348/78

(57) ABSTRACT

The invention provides an apparatus and method for positioning an iris for iris image capture. An iris image sensor is configured to have an image capture region defining an intended position of the subject's iris for image capture. An optical system comprising a reflective element is disposed such that, responsive to positioning of the subject's iris within the image capture region, the optical system forms a subject viewable in-focus upright image of the subject's iris. The optical system may be configured such that length of an optical path between the intended position of the subject's iris during image capture and the reflective element is less than half of a near point distance. The optical system may be further configured such that a distance between the image capture region and the in-focus upright image formed by the optical system is greater than or equal to the near point distance.

### CROSS-REFERENCE TO RELATED APPLICATION

This application claims priority to U.S. Provisional Application No. 61/819,931 filed on May 6, 2013, the contents of which is incorporated herein by reference in its entirety.

### FIELD OF INVENTION

The invention relates to an imaging apparatus, for obtaining images of one or more features of a subject's eye for biometric identification. The invention is particularly operable to obtain images of a subject's iris for iris recognition.

### BACKGROUND

Methods for biometric identification based on facial features, including features of the eye are known. Methods for iris recognition implement pattern-recognition techniques to compare an acquired image of a subject's iris against a previously acquired image of the subject's iris, and thereby determine or verify identity of the subject. A digital template corresponding to an acquired iris image is encoded based on the image, using mathematical/statistical algorithms. The digital template is thereafter compared against databases of previously encoded digital templates (corresponding to previously acquired iris images), for locating a match and thereby determining or verifying identity of the subject.

Iris recognition systems are known to acquire images of the iris in the visible region (400 nm to 700 nm) or the near infrared region (700-900 nm) of the electromagnetic spectrum or a combination of both.

Apparatuses for iris recognition may comprise an imaging apparatus for capturing an image of the subject's iris(es) and an image processing apparatus for comparing the captured image against previously stored iris image information. The imaging apparatus and image processing apparatus may comprise separate devices, or may be combined within a single device.

In operation, it has been found that (i) positioning of the subject's eye and (ii) orientation of the subject's iris, relative to the imaging apparatus has consequences for image acquisition and for optimizing encoding and subsequent matching of digital templates of iris images.

FIG. 1 illustrates some considerations for correct positioning of the subject's eye for image capture. As illustrated in FIG. 1, iris camera IC has a finite and fixed field of view FOV (i.e. the volume of inspection capable of being captured on the camera's image sensor). In FIG. 1, field of view FOV is the region defined by dashed lines Fv1 and Fv2. Iris camera IC additionally has a depth of field DOF—wherein depth of field DOF defines the region within which a subject's iris would appear acceptably sharp and in sufficient detail for the purposes of iris image capture. In FIG. 1, depth of field DOF is the region between dashed lines Df1 and Df2, along the z axis. While not specifically illustrated in the accompanying drawings, iris camera IC may include an image sensor and a camera lens.

For image acquisition, subject's eye E is required to be positioned within an image capture region defined by the intersection of the field of view FOV and the depth of field DOF—which ensures that the acquired iris image has sufficient sharpness and detail. Portions of subject's eye E that remain outside the field of view FOV region would not be acquired by iris camera IC. Similarly, if subject's eye E is positioned outside the depth of field DOF region, the acquired image may be unfocussed (if outside the depth of field DOF region in the direction towards iris camera IC) or may have insufficient iris texture detail (if outside the depth of field DOF region in the direction away from the iris camera IC).

In addition to positioning the subject's eye correctly within the image capture region defined by the intersection of the field of view FOV and depth of field DOF), it is also preferable to ensure appropriate orientation of the subject's iris with respect to optical axis O of iris camera IC, to ensure that portions of the iris are not distorted or occluded during image acquisition. For example, if the subject's gaze is directed peripherally, the iris moves towards the sides of the eye socket opening, which results in image acquisition of only a portion of the iris and/or a distorted view of the iris. For optimal iris image acquisition, the iris should be positioned substantially towards the centre of the eye socket opening and substantially centred along the optical axis O of iris camera IC for image acquisition.

The objectives of (i) positioning of a subject's eye and (ii) ensuring optimal orientation of the iris relative to the optical axis of the iris camera, may be addressed by providing a feedback object on which the subject is required to direct its gaze for image acquisition. The feedback object is positioned so that, in directing its gaze towards the feedback object for viewing, the subject's eye assumes a correct position within the image capture region defined by the intersection of the iris camera's field of view and depth of field. The feedback object is additionally positioned in a manner that, directing a subject's gaze towards the feedback object ensures optimal positioning of the iris within the eye socket opening and also along the optical axis of the camera.

The feedback object may be any visible object, and is located to ensure appropriate positioning of the eye and also the iris for image acquisition. Examples of feedback objects include numerals, characters, text, illustrations, images or sources of illumination. The feedback object may be illuminated by ambient light for viewing, or alternatively may be illuminated by one or more light sources within the imaging apparatus.

One implementation of a feedback object for ensuring positioning of the subject's eye comprises a reflective element (such as a mirror) disposed within the imaging apparatus. When the subject's eye is appropriately positioned within the iris camera's field of view for image acquisition, the reflective element forms an image of the subject's eye, which image is visible to the subject. The image so formed provides a positive visual indication that the subject's eye is appropriately positioned for imaging. Where the reflective element is an appropriately curved reflective element (such as a concave mirror) an image of the subject's eye only appears in-focus when the subject's eye is positioned within the depth of field region of the iris camera. If the eye is within the field of view but outside the depth of field of the iris camera, the subject would see a distorted or unfocussed image of its own eye—thereby providing a visual indication of incorrect positioning. It would be understood that in this instance the subject's eye serves as a feedback object.

In a particular implementation of the feedback object, the curved reflective element may comprise an optical filter (such as a band-pass filter or a cold mirror) positioned between the iris camera and the subject's eye. The optical filter may be selected to allow infrared radiation to pass through while reflecting visible wavelengths. This ensures that visible light is reflected to form an image of the subject's eye, while infrared wavelengths are allowed to reach the iris camera for image acquisition.

A drawback in prior art systems for iris imaging is observed when, due to either size/space limitations or limited depth of field of the iris camera, the subject's eye requires to be positioned very near the feedback object.

The human eye is unable to focus properly on objects that are closer than a certain distance from the eye. The closest point at which an object can be brought into focus by the eye is called the eye's “near point” and this near point is generally understood to lie approximately 25 cm away from the eye for a normal adult. For the purposes of this written description, the distance between a subject's eye and the eye's near point shall be referred to as the “near point distance” of the eye.

The eye's near point presents a significant limitation when providing a feedback object to enable positioning of the eye in front of an iris camera, since such feedback object would require to be positioned at least 25 cm away from the eye to enable proper viewing. Since in certain apparatuses, both the iris camera and the feedback object are disposed on or within the imaging apparatus, having to position the eye 25 cm (or further) away from the feedback object necessitates that the imaging apparatus (and consequently the iris camera) be positioned at least 25 cm away from the subject's eye during image acquisition. This in turn requires that the iris camera have an image capture distance of at least 25 cm.

Cameras that do not support an image capture distance at least 25 cm therefore present challenges to being combined with iris positioning systems for image acquisition—for the reason that they are unable to support the necessary 25 cm separation between the subject's eye and the imaging apparatus. This is particularly observed in cameras that are built into handheld communication devices or mobile computing devices (such as mobile phones, smart phones, personal digital assistants, tablets or laptop devices), where as a consequence of (i) attempts to reduce thickness of the handheld communication devices, (ii) reduced size of the iris camera, and (iii) the need to enable capture of an iris image having sufficient optical and pixel resolution—the image capture distance necessary to enable iris imaging (of sufficient sharpness and detail) is usually much less than 25 cm, and may be in the region of less than 12.5 cm.

Additionally, having to ensure distances of 25 cm or more between the eye and a feedback object disposed on or within an imaging apparatus has been found to significantly increase the size of the imaging apparatus itself.

In addition to the above drawbacks in the art, it is also preferable to minimize angular deviation between the horizontal and vertical axes of a subject's head and/or eye(s) (and therefore the iris) relative to the corresponding horizontal and vertical axes of the iris camera.

While subjects tend to naturally position their heads in a substantially vertical orientation (i.e. without significant angular deviation relative to the horizontal and vertical axes) for image acquisition, inadvertent tilt of the iris camera may give rise to undesirable angular deviations.

It is preferred that iris images are acquired by an iris camera when (i) the angular deviation between the respective vertical axes of the subject's iris and the iris camera is zero, and (ii) the angular deviation between the respective horizontal axes of the subject's iris and the iris camera is zero.

While known encoding and comparative algorithms for iris recognition can mathematically compensate for angular deviations from the respective axes of the subject's iris and the iris camera, of anywhere between 0° and 360°, compensation adds to computational complexity and execution time. There are therefore advantages that arise from minimizing, or eliminating entirely, angular deviation between the respective horizontal and vertical axes of the subject's head (and iris) and the iris camera, at the time of image acquisition.

### SUMMARY OF THE INVENTION

The invention provides an iris imaging apparatus for acquiring an image of a subject's iris. The apparatus comprises an iris camera and an optical system. The iris camera comprises an image sensor, and is configured to have an image capture region defining an intended position of the subject's iris for iris image capture. The optical system may comprise a reflective element disposed such that, responsive to positioning of the subject's iris within the image capture region, the optical system forms a subject viewable in-focus upright image of the subject's iris. The optical system may be configured such that length of an optical path between the intended position of the subject's iris during image capture and the reflective element is less than half of a near point distance, the near point distance defining a shortest distance from an eye at which an object is capable of in-focus viewing by the eye. Further, the optical system may be configured such that a distance between the image capture region and the in-focus upright image formed by the optical system is greater than or equal to the near point distance.

The near point distance defining the shortest distance from an eye at which an object is capable of in-focus viewing by the eye is typically 25 cm.

In an embodiment of the iris imaging apparatus, a distance between the image capture region and the image sensor is less than half the near point distance.

The reflective element of the iris imaging apparatus may comprise an optical element configured to reflect at least some visible wavelengths while allowing passage of at least some infrared wavelengths onward to the iris camera. The reflective element may be positioned to one side of the iris camera, such that the reflective element is entirely removed from an optical axis of the iris camera.

An embodiment of the iris imaging apparatus may include a substantially transparent plano-parallel element disposed between (i) the image capture region and (ii) the reflective element and the iris camera, such that deviation between the iris camera's lens axis and an axis perpendicular to the plano-parallel element, is between 00 and 50.

The reflective element of the iris imaging apparatus may be disposed such that in viewing the in-focus upright image of the subject's iris, either the subject's eye is looking in a direction of the iris camera, or deviation between a direction in which the subject's eye is looking and the direction of the iris camera is between 0o and 30o. The reflective element of the iris imaging apparatus may be selected and positioned such that the image capture region lies between the reflective element and focal point of the reflective element. In an embodiment, the reflective element may comprise an angle selective reflective element configured to reflect incident light only at predetermined angles of incidence. The reflective element may comprise one of a concave, plano-convex, or plano-concave reflective element.

The iris imaging apparatus may additionally include a smart glass element disposed between the reflective element and the image capture region. In one embodiment, the reflective element is a smart glass reflective element.

In an embodiment of the iris imaging apparatus, wherein configuration of the optical system may be based on (i) the near point distance and (ii) distance between the reflective element and the intended position of the subject's iris during image capture. In another embodiment, the iris imaging apparatus is configured such that the image capture distance between the subject's iris and the reflective element is less than 12.5 cm.

The reflective element of the iris imaging apparatus may be comprise a reflective portion and a non-reflective portion, such that the reflective portion reflects at least some visible wavelength radiation scattered from the subject's iris when the subject's iris is positioned within the image capture region, and the non-reflective portion allows at least some radiation scattered from the subject's iris when the subject's iris is positioned within the image capture region, to pass through the reflective element and on to the image sensor for image acquisition.

The non-reflective portion of the reflective element may comprise at least one of a hole through the reflective element or a discontinuity in a reflective surface of the reflective element.

In an embodiment, the non-reflective portion allows passage of visible wavelength radiation and infrared wavelength radiation through the reflective element and on to the image sensor for image acquisition. The non-reflective portion may define a non-reflective aperture at a center of the reflective element.

The reflective portion of the reflective element may additionally reflect infrared wavelength radiation. In an embodiment, the reflective portion may comprise a mirror surface.

The reflective element may be positioned such that optical axis of the iris camera passes through the non-reflective portion.

The reflective element of the invention may be positioned such that, responsive to positioning of the subject's iris within the image capture region, the non-reflective portion of the reflective element coincides with location of the subject's pupil in the image formed by the reflective element.

The reflective element of the invention may comprise one of a concave reflective element, a plano-convex reflective element having a flat reflective surface disposed proximal to the iris camera and a convex lens surface disposed distal to the iris camera, or a plano-convex reflective element having a convex reflecting surface disposed proximal to the iris camera and a planar lens surface disposed distal to the iris camera.

The non-reflective portion may comprise an aperture in the reflective element, said aperture configured and sized to house at least a portion of the iris camera therewithin.

In an embodiment of the invention, the iris imaging apparatus may be disposed within a device housing having a substantially transparent surface.

The invention additionally comprises a method of configuring an iris imaging apparatus for acquiring an image of a subject's iris. An iris camera comprising an image sensor is configured to have an image capture region defining an intended position of the subject's iris during image capture. An optical system comprising a reflective element is positioned such that, responsive to positioning of the subject's iris within the image capture region, the optical system forms a subject viewable in-focus upright image of the subject's iris—wherein a distance between the image capture region and the reflective element is less than half a near point distance, the near point distance defining a shortest distance from an eye at which an object is capable of in-focus viewing by the eye, and wherein a distance between the image capture region and the in-focus upright image formed by the optical system is greater than or equal to the near point distance.

The invention additionally provides a kit for an iris imaging apparatus for acquiring an image of a subject's iris. The kit comprises an iris camera and an optical system. The iris camera comprises an image sensor, and is configured to have an image capture region defining an intended position of the subject's iris during image capture. The optical system comprises a reflective element, the reflective element configured for disposition such that, responsive to positioning of the subject's iris within the image capture region, the optical system forms a subject viewable in-focus upright image of the subject's iris. The optical system may be configured such that a distance between the intended position of the subject's iris during image capture and an intended position of the reflective element is less than half a near point distance, the near point distance defining a shortest distance from an eye at which an object is capable of in-focus viewing by the eye. The optical system may additionally be configured such that a distance between the intended position of the subject's iris during image capture and an intended position of the in-focus upright image formed by the optical system is greater than or equal to the near point distance.

### BRIEF DESCRIPTION OF THE ACCOMPANYING DRAWINGS

FIG. 1 illustrates positioning of the subject's eye for image capture by an iris camera.

FIG. 2 is a functional block diagram of an apparatus for iris recognition.

FIG. 3 illustrates a reflective optical system forming a virtual, upright, in-focus image of a subject's eye beyond the near point distance of the eye.

FIGS. 4 to 6 illustrate embodiments of an imaging apparatus having a reflective optical system for providing an image of a subject's eye as a feedback object.

FIGS. 6A to 6C illustrate various orientations of an iris camera and reflective optical system of an imaging apparatus.

FIG. 7 illustrates an embodiment of an imaging apparatus having a reflective optical system interposed between the subject's eye and the iris camera.

FIG. 8 illustrates an optical system forming a virtual image of a feedback object beyond the near point distance of a subject's eye.

FIGS. 9 to 12F illustrate embodiments of an imaging apparatus having an optical system for forming a virtual image of a feedback object.

FIGS. 13 and 14 illustrate other embodiments of an imaging apparatus having a reflective optical system interposed between the subject's eye and the iris camera.

FIGS. 15A to 15F illustrate embodiments of a reflective optical system for an imaging apparatus.

FIGS. 16A to 16F illustrate particular embodiments of a reflective optical system for an imaging apparatus disposed within a housing.

FIGS. 17A and 17B illustrate exemplary optical elements for altering an optical path between objects.

FIG. 18 illustrates an exemplary computer system in which various embodiments of the invention may be implemented.

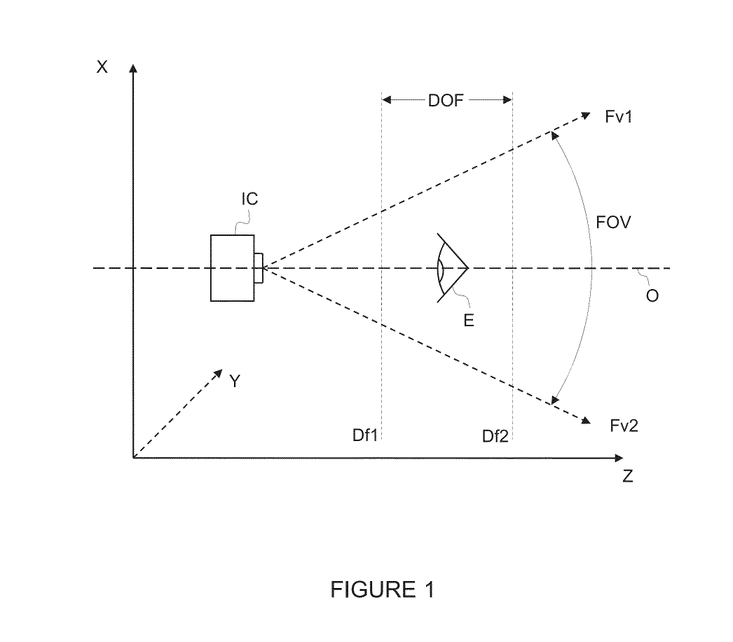

### DETAILED DESCRIPTION

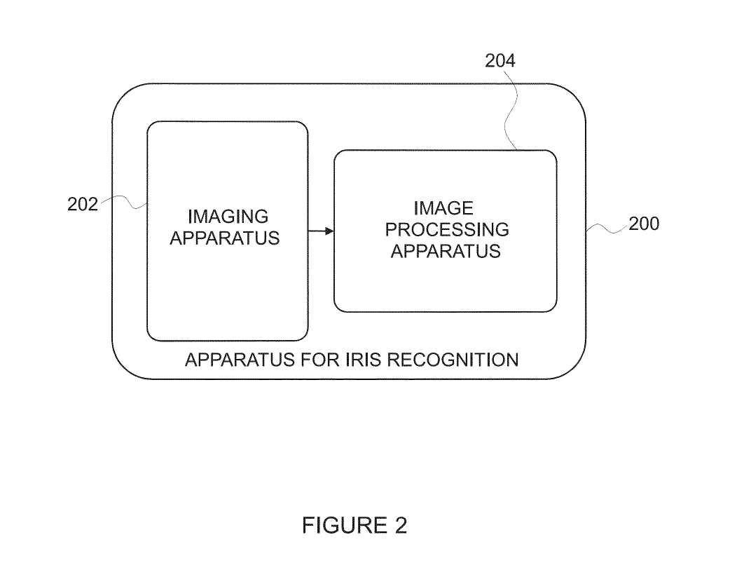

FIG. 2 is a functional block diagram of an apparatus for iris recognition, comprising an imaging apparatus 202 and an image processing apparatus 204. Imaging apparatus 202 acquires an image of the subject's iris and transmits the image to image processing apparatus 204. The image captured by imaging apparatus 202 may be a still image or a video image. Image processing apparatus 204 thereafter analyses and compares a digital template encoded based on the captured image of the subject's iris against digital templates encoded based on previously acquired iris images, to identify the subject, or to verify the identity of the subject.

Although not illustrated in FIG. 2, apparatus for iris recognition 200 may include other components, including for extracting still frames from video images, for processing and digitizing image data, enrollment (the process of capturing, and storing iris information for a subject, and uniquely associating the stored information with that subject) and comparison (the process of comparing iris information acquired from a subject against information previously acquired during enrollment, for identification or verification of the subject's identity), and for enabling communication between components of the apparatus. The imaging apparatus, image processing apparatus and other components of an apparatus for iris recognition may each comprise separate devices, or may be combined within a single device.

The invention provides a system for alignment or positioning of a subject's eye for iris image capture.

In an embodiment, the system includes a feedback object to enable correct positioning of the eye and the iris itself, wherein the distance between the feedback object and the subject's eye at the time of image acquisition is less than the near point distance of the eye, and in a further embodiment is less than half the near point distance of the eye. The invention achieves this by providing an optical element which forms a subject viewable, in-focus, upright image of the feedback object in front of the subject's eye, such that the distance between the image of the feedback object and the subject's eye is greater than or equal to the near point distance of the eye.

In a first embodiment of the invention, the feedback object is the subject's eye when positioned for image acquisition, and the in-focus upright image of the feedback object is a reflection of the subject's eye, where the reflection is formed by a reflective element.

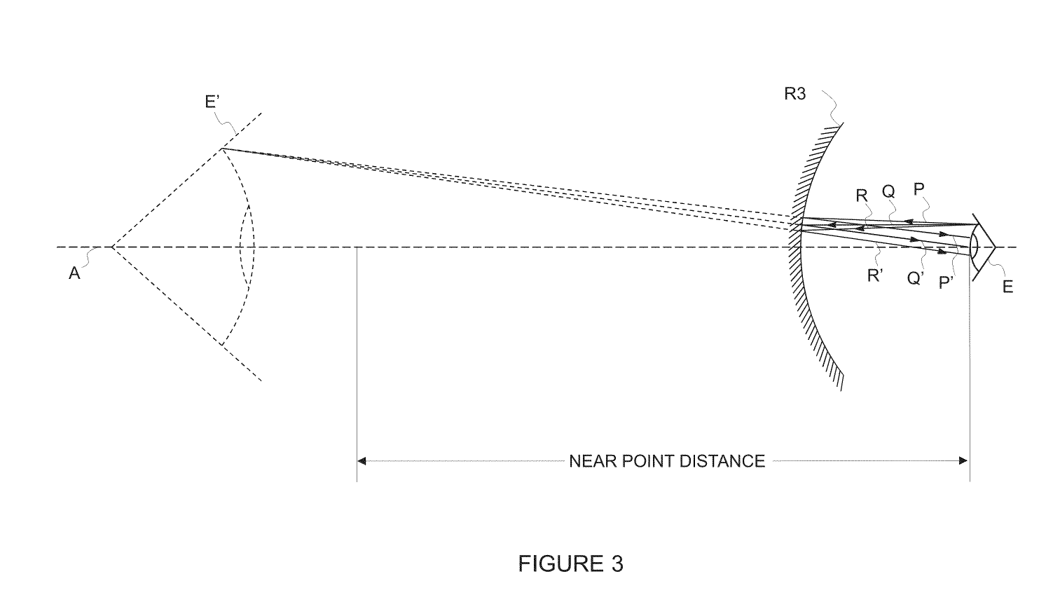

FIG. 3 illustrates optical principles for understanding how a virtual image of an object may be formed beyond the near point distance of the eye, in an implementation involving a reflective element.

In FIG. 3, incident rays P, Q and R scattered from eye E are reflected off reflective element R3, and are incident upon eye E as reflected rays P′, Q′ and R′. The image location for virtual image E′ can be found by tracing reflected rays P′, Q′ and R′ backwards to where they intersect. For the subject, the reflected rays would appear to diverge from this point, which serves as the image point. By appropriate selection of a reflective element based on the desired object distance (the distance at which the subject's eye is intended to be positioned for optimal image acquisition) and the near point distance, it can be ensured that the virtual image of the subject's eye is formed upright, in front of the eye and at a distance (along optical axis A) at or beyond the near point of the eye. In certain embodiments, reflective element R4 may be positioned such that in viewing the reflection of eye E, either (i) the subject's eye is looking in the direction of the iris camera, or (ii) the deviation between a direction in which the subject's eye is looking and a direction at which the iris camera is located relative to the eye is between 0° and 30°.

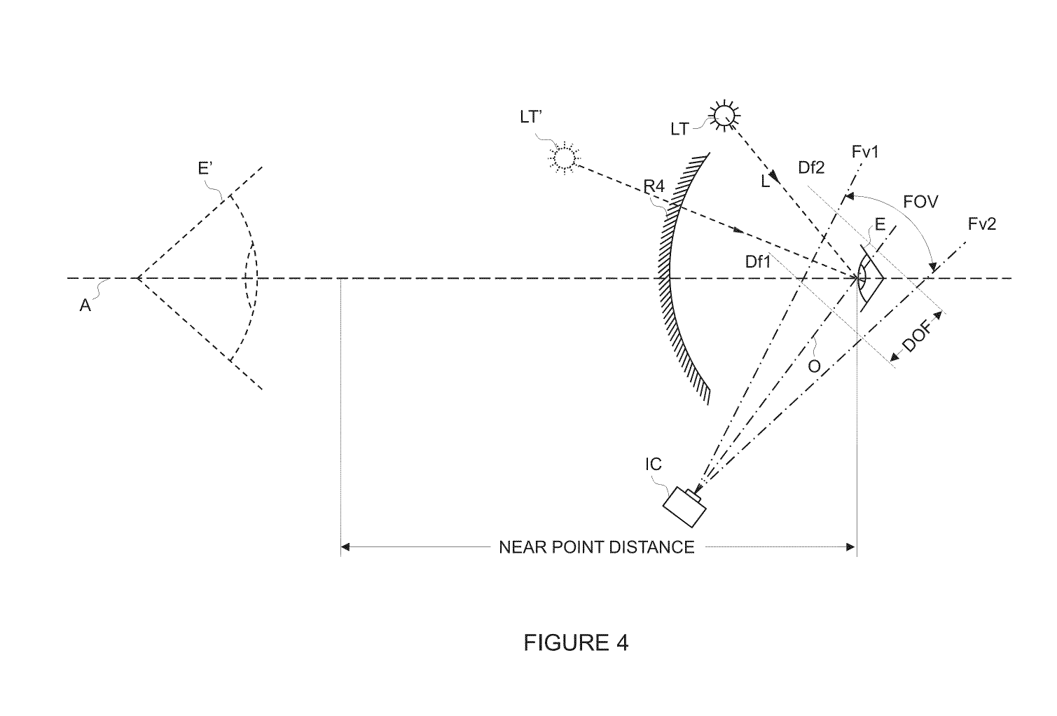

FIG. 4 illustrates an embodiment of the invention, where the feedback object is a reflection of the subject's eye. The illustrated embodiment comprises iris camera IC and reflective element R4, wherein R4 is positioned such that the subject sees an upright, in-focus reflection of its eye E in reflective element R4 only when eye E is within the image capture region defined by the intersection of the field of view region FOV and depth of field region DOF of iris camera IC. In directing the subject's gaze towards reflective element R4 to observe the reflection of eye E, the subject's iris assumes an orientation appropriate for optimal image acquisition by iris camera IC i.e. where the iris is substantially centred along optical axis O of iris camera IC.

In the illustrated embodiment, reflective element R4 is a concave mirror located such that the distance between the concave mirror and the subject's eye is less than the near point distance. Reflective element R4 is selected such that when eye E is within the image capture region defined by the intersection of the field of view region FOV and depth of field region DOF of iris camera IC, the distance between upright virtual image E′ and eye E, along optical axis A, is greater than or equal to the near point distance. In a preferred embodiment, the distance between the concave mirror and the subject's eye is less than half the near point distance, and reflective element R4 may be selected such that when eye E is within the image capture region defined by the intersection of the field of view region FOV and depth of field region DOF of iris camera IC, the distance between upright virtual image E′ and eye E, along optical axis A, is greater than or equal to the near point distance.

By forming an image at a distance greater than or equal to the near point distance of the eye, the subject is able to view a focussed image of the eye, when in the correct position for image acquisition—despite the physical distance between reflective element R4 and eye E being less than the near point distance.

In the embodiment illustrated in FIG. 4, concave mirror R4 may be selected and positioned such that (i) the image capture region defined by the intersection of the filed of view region FOV and the depth of field region DOF of iris camera IC lies between mirror R4 and the focal point of mirror R4, and (ii) the distance between virtual image E′ and eye E is greater than or equal to the near point distance.

As illustrated in FIG. 4, the invention may include an illumination source LT for illuminating eye E for image capture.

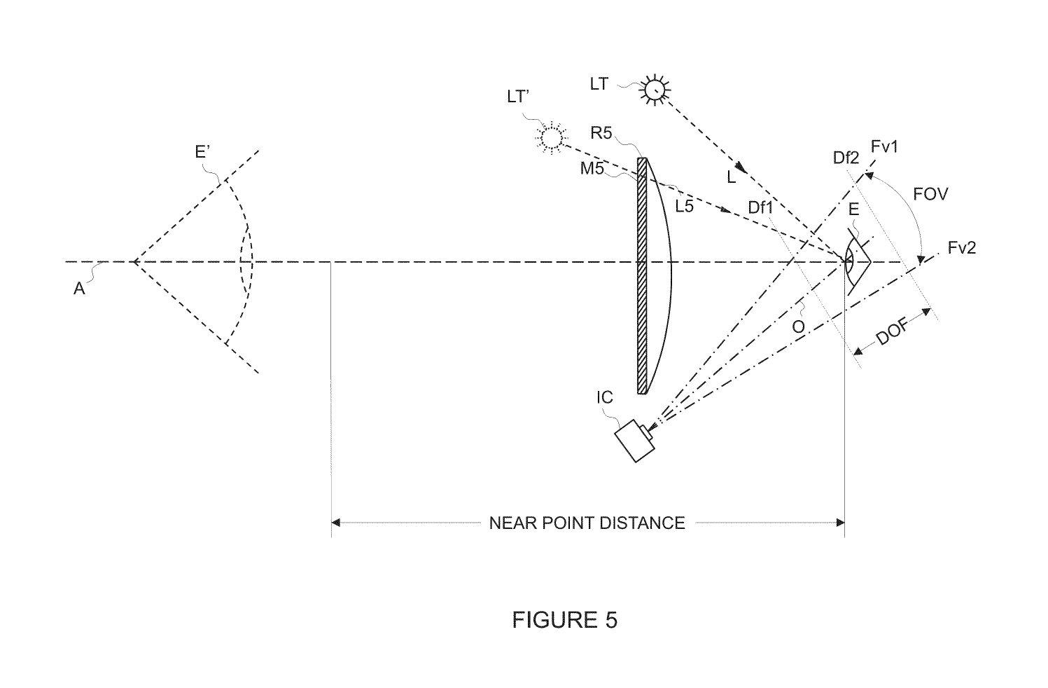

FIG. 5 illustrates a second embodiment of the invention, where the feedback object is a reflection of the subject's eye. The embodiment comprises iris camera IC and reflective element R5, wherein R5 is positioned such that the subject would see an upright, in-focus reflection of its eye E in reflective element R5 only when eye E is within the image capture region defined by the intersection of the field of view region FOV and depth of field region DOF of iris camera IC. In directing the subject's gaze towards reflective element R5 to observe the reflection of eye E, the subject's iris assumes an orientation appropriate for optimal image acquisition by iris camera IC i.e. where the iris is substantially centred along optical axis O of iris camera IC.

In the embodiment illustrated in FIG. 5, reflective element R5 is a plano-convex mirror element having flat (or substantially flat) reflective element M5 disposed distal to eye E, and convex lens element L5 disposed proximal to eye E. It would be understood that reflective element M5 and convex lens element L5 may be integrally formed, or may have been formed by reversible or irreversible coupling of two discrete elements. Reflective element M5 and convex lens element L5 may alternatively be two discrete elements disposed adjacent or substantially adjacent to each other. In an embodiment, reflective element R5 may comprise a plano-convex lens L5 wherein the planar face has been treated or covered with a reflective coating. In another embodiment reflective element R5 may rely upon partial reflection off planar surface M5, which surface may or may not be provided with a reflective coating.

Reflective element R5 is located at a distance less than the near point distance away from the subject's eye during image acquisition. Reflective element R5 is selected such that, when eye E is within the image capture region defined by the intersection of the field of view region FOV and depth of field region DOF of iris camera IC, an upright, in-focus virtual image E′ is formed at a distance from subject's eye E that is greater than or equal to the near point distance. In a preferred embodiment, reflective element R5 is located at a distance less than half the near point distance away from the subject's eye during image acquisition. In such embodiment, reflective element R5 is selected such that, when eye E is within the image capture region defined by the intersection of the field of view region FOV and depth of field region DOF of iris camera IC, an upright, in-focus virtual image E′ is formed at a distance from subject's eye E that is greater than or equal to the near point distance.

In the embodiment illustrated in FIG. 5, plano-convex element R5 may be selected such that (i) it has a focal point at or further than eye E, and (ii) the virtual image E′ is an upright, magnified image formed at a distance from eye E that is greater than or equal to the near point distance.

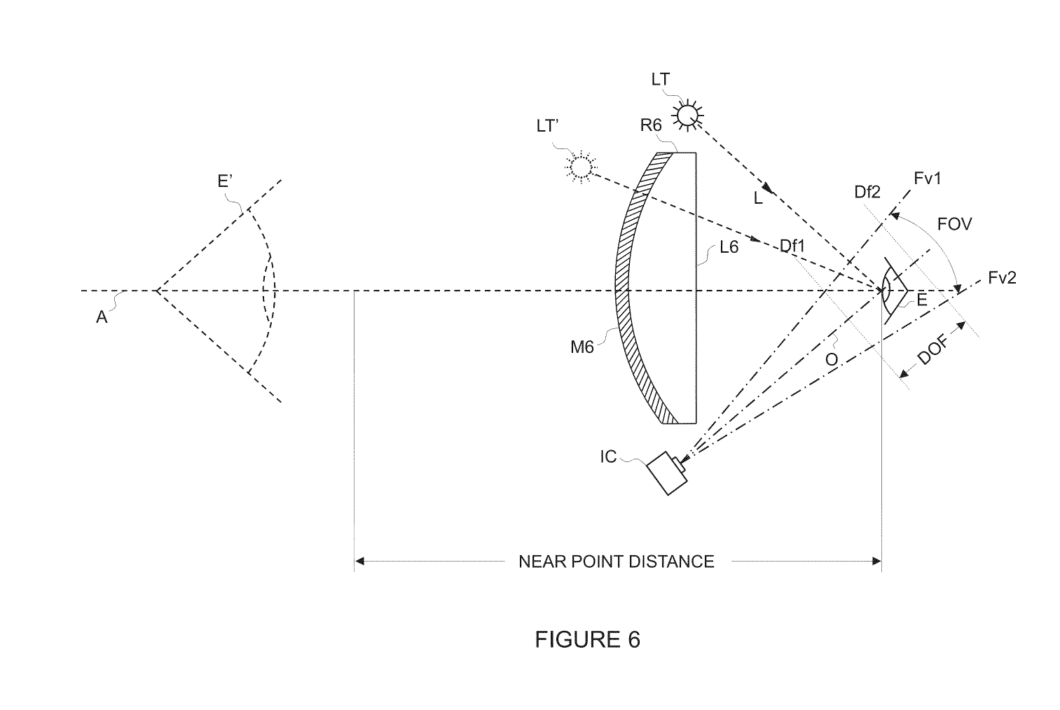

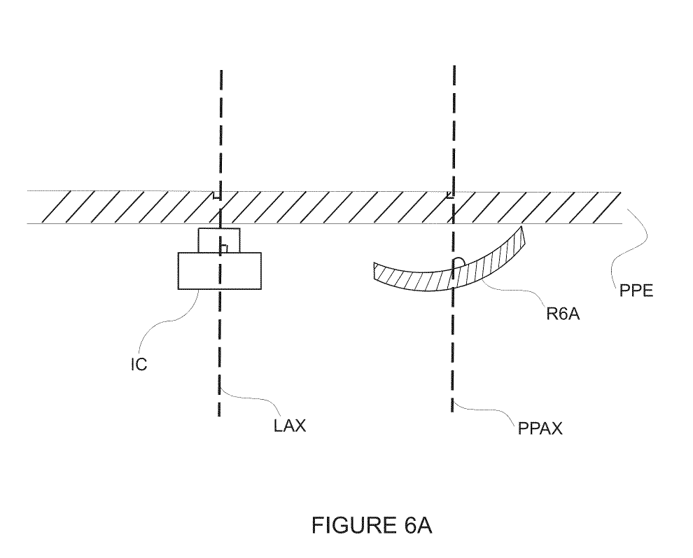

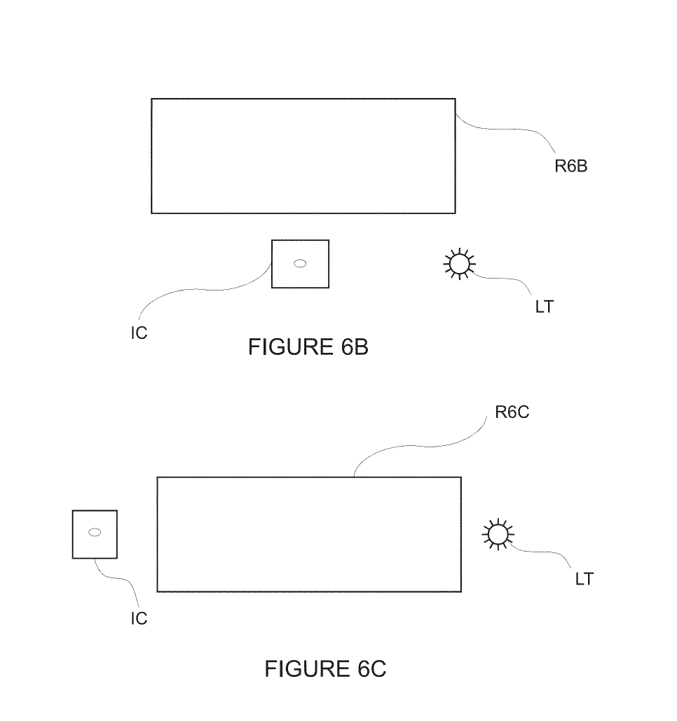

FIG. 6 illustrates a further embodiment of the invention, where the feedback object is a reflection of the subject's eye. The embodiment comprises iris camera IC and reflective element R6, wherein R6 is positioned such that the subject would see an upright, in-focus reflection of its eye E in reflective element R6 only when eye E is within the image capture region defined by the intersection of the field of view region FOV and depth of field region DOF of iris camera IC. In directing the subject's gaze towards reflective element R6 to observe the reflection of eye E, the subject's iris assumes an orientation appropriate for optimal image acquisition by iris camera IC i.e. where the iris is substantially centred along optical axis O of iris camera IC. In certain embodiments, reflective element R6 may be positioned such that in viewing the reflection of eye E, either (i) the subject's eye is looking in the direction of the iris camera, or (ii) the deviation between a direction in which the subject's eye is looking and a direction at which the iris camera is located relative to the eye is between 0° and 30°.

Reflective element R6 is a plano-convex mirror element having convex reflective surface M6 disposed distal to eye E, and planar lens surface L6 disposed proximal to eye E. It would be understood that convex reflective surface M6 and planar lens portion L6 may be integrally formed, or may have been formed by the reversible or irreversible coupling of two discrete elements. Reflective element M6 and lens portion L6 may alternatively be two discrete elements disposed adjacent or substantially adjacent to each other. In an embodiment reflective element R6 may simply comprise a single plano-convex lens wherein the convex face has been treated with a reflective coating.

Reflective element R6 may preferably be located at a distance less than the near point distance away from the subject's eye during image acquisition. Yet more preferably, reflective element R6 may preferably be located at a distance less than half the near point distance away from the subject's eye during image acquisition. Reflective element R6 is selected such that when eye E is within the image capture region defined by the intersection of the field of view region FOV and depth of field region DOF of iris camera IC, a virtual image E′ is formed at a distance from eye E that is greater than or equal to the near point distance.

In the embodiment illustrated in FIG. 6, plano-convex element R6 may be selected such that (i) it has a focal point at or farther than eye E, and (ii) virtual image E′ is an upright, magnified image formed at a distance from eye E that is greater than or equal to the near point distance.

While the embodiments illustrated in FIGS. 4, 5 and 6 are discussed in terms of specific configurations of a reflective element, the invention can equally implement any reflective optical system comprising a reflective or partially reflective element or a combination of reflective elements with other optical elements, and configured such that if the distance between such reflective optical system and the subject's eye is less than the near point distance (or more preferably is less than half the near point distance), the distance between a reflected image E′ and subject's eye E is greater than or equal to the near point distance. For the purposes of this disclosure, the terms “reflective element” and “reflective optical system” shall be understood to be interchangeable.

Yet further, in an embodiment of the invention described in connection with FIGS. 4, 5 and 6, the reflective element and iris camera may be positioned relative each other such that a distance between (i) the image sensor of the iris camera and (ii) the image capture region defined by the intersection of field of view FOV and depth of field DOF, is less than half the near point distance.

In the embodiments illustrated in FIGS. 4, 5 and 6 the reflective element is positioned adjacent to, or to one side of the iris camera, so that the reflective element is entirely removed from optical axis O of iris camera IC. FIG. 6B illustrates an embodiment of the invention wherein reflective element R6B is positioned adjacent to and vertically above iris camera IC and illumination source LT is positioned adjacent to and on one side of iris camera IC. FIG. 6C illustrates another embodiment of the invention wherein iris camera IC is positioned adjacent to and to one side of reflective element R6C, and illumination source LT is positioned adjacent to and to an opposite side of reflective element R6C.

Similarly, in the embodiments illustrated in FIGS. 4, 5, 6B and 6C, an illumination source LT may be provided for illuminating eye E for image capture. In the illustrated embodiments, illumination source LT is positioned adjacent to, or to one side of the reflective element (R4, R5, R6), so that the reflective element does not interfere with transmission of illuminating radiation from illumination source LT to eye E.

FIGS. 4, 5 and 6 also illustrate an alternative positioning for the illumination source, wherein the reflective element (R4, R5, R6) is interposed between alternative illumination source LT′ and the subject's eye E. In this alternative implementation, the reflective element (R5, R5, R6) comprise an optical filter (such as a band-pass filter or a cold mirror) positioned between illumination source LT′ and the subject's eye E. The optical filter is selected to allow infrared radiation from illumination source LT′ to pass through en route to the subject's eye E, while reflecting visible wavelengths reflected off the subject's eye E. This ensures that visible light is reflected to form an image of the subject's eye, while infrared wavelengths generated by illumination source LT′ are allowed to reach the subject's eye E to illuminate the eye for image acquisition.

It would be understood that one implementation of the iris imaging apparatus described in this written description is within handheld devices having in-built cameras (such as mobile phones, laptops, tablets, personal digital assistants etc.). This may be achieved by incorporating the iris camera as well as the reflective element within a housing for the handheld device—wherein the iris camera and the reflective element have a transparent or substantially transparent plano-parallel element (such one or more glass windows) disposed between them and the image capture region.

It has been discovered that unless the iris camera lens element is perpendicular or substantially perpendicular to the plano-parallel element, significant reductions in image quality tend to occur. With a view to ensure optimal image capture, the iris camera is therefore disposed within the housing such that deviation between the iris camera's lens axis and an axis perpendicular to the transparent (or substantially transparent) plano-parallel element is between 0° and 5°. Yet more preferably, in the embodiment where the iris camera lens is disposed to ensure that the iris camera lens element is perpendicular or substantially perpendicular to the plano-parallel element, the reflective element may be tilted relative to an axis perpendicular to the plano-parallel element to a degree sufficient to ensure that when the subject's eye is positioned within the image capture region, the subject is able to see an upright, in-focus image of its iris, in the reflective element. In an embodiment, the reflective element is tilted by 5° or more relative to an axis perpendicular to the plano-parallel element.

FIG. 6A illustrates an embodiment of the invention where (i) the iris camera IC and reflective element are disposed on one side of a transparent plano-parallel element PPE, and (ii) the iris camera is disposed such that the iris camera's lens axis LAX is substantially perpendicular to the transparent (or substantially transparent) plano-parallel element PPE and (iii) the reflective element is tilted relative to an axis PPAX perpendicular to the plano-parallel element.

By way of explanation, for the purposes of this and similar embodiments, the terms “tilt” and “tilted” describe configuration and disposition of the reflective optical system wherein (i) the reflective optical system is disposed to one side of the iris camera and (ii) the reflective element is disposed relative to the iris camera lens axis, such that a subject viewable in-focus upright virtual image of the subject's eye is formed in the reflective optical system (in a preferred embodiment, substantially in the centre of the reflective optical system) when the eye is located within the image capture region.

Non-limiting embodiments for achieving the desired tilt arrangement of the reflective optical system may include one or more of (i) adding a prism disposed between a reflective element and the image capture region and located close to the reflective element, and b) providing an appropriate linear offset between the iris camera and one or more surface of the reflective optical system.

While the embodiments illustrated in FIGS. 4 to 6A are discussed in terms of specific configurations of a reflective element, the invention can equally implement any reflective optical system comprising a reflective or partially reflective element or a combination of reflective elements with other optical elements, and configured such that if the distance between such reflective optical system and the subject's eye is less than the near point distance (or more preferably is less than half the near point distance), the distance between a reflected image E′ and subject's eye E is greater than or equal to the near point distance. For the purposes of this disclosure, the terms “reflective element” and “reflective optical system” shall be understood to be interchangeable.

As explained below, selection of an optical element or a reflective optical system appropriate for implementation in the invention as illustrated in FIGS. 4, 5 and 6 may be a function of (i) the near point distance and (ii) the distance between the subject's eye and the optical element, when the subject's eye is within the depth of field of the iris camera.

In an embodiment, the reflective element may be selected and positioned such that the image capture region lies between the reflective element and focal point of the reflective element.

In an embodiment of the invention where the feedback object is a reflection of the subject's eye itself, the reflective optical system may comprise an angle-selective reflective element—i.e. a reflective element which reflects incident light at only a single selected angle of incidence or a selected range of angles of incidence. In an embodiment, the angle-selective reflective element is chosen such that the surface is reflective only within angles of incidence that correspond with the field of view of the iris camera—thereby ensuring that the subject will only be able to view a reflection of its eye when positioned within the field of view or the iris camera. In another embodiment, the angle-selective reflective element may be included only with a view improving appearance of the device.

In another embodiment of the invention, a switchable “smart glass” element is disposed in front of the reflective element. Smart glass elements enable switchable control of the amount of light transmitted therethrough. When subjected to a state change, the smart glass changes from a first transparent/translucent state to a second reflective or opaque state. Non-limiting examples of smart glass elements include electrochromic devices, suspended particle devices, micro-blinds and liquid crystal devices. In an embodiment, the smart glass element disposed in front of reflective element is maintained in a first darkened/opaque state until iris recognition is required. The smart glass element may at that stage be subjected to a state change (for example to a translucent/transparent state) so that the subject is able to view the reflective element disposed behind the smart glass element, for iris alignment. In one embodiment, the smart glass element is an electrochromic element, which is moved from a first state to a second state by subjecting it to a voltage differential. In another embodiment the reflective element of the reflective optical system comprises a “smart glass” element which can change from an reflective state to a translucent/transparent state and thereby exposes an object behind this “smart glass” reflective element (for example a black background).

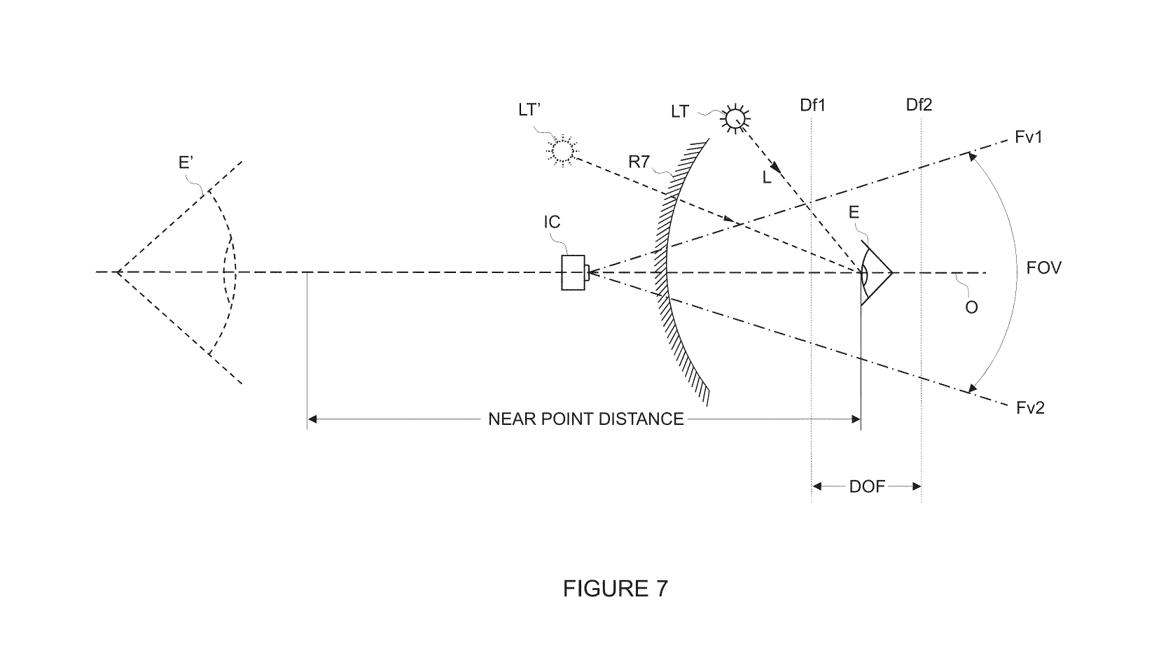

FIG. 7 illustrates an embodiment of the invention where the feedback object is a reflection of the subject's eye itself, and where reflective optical system R7 is disposed between subject's eye E and iris camera IC, along optical axis O. In the illustrated embodiment, reflective optical system R7 may be a cold mirror, or other optical filter which reflects visible wavelengths but allows certain infrared wavelengths to pass through for image acquisition by iris camera IC. Reflective optical system R7 is selected and positioned such that the subject sees an upright, in-focus reflection of its eye E in reflective optical system R7 only when eye E is within the image capture region defined by the intersection of the field of view region FOV and depth of field region DOF of iris camera IC.

In the illustrated embodiment, reflective optical system R7 is a concave mirror located at a distance less than the near point distance away from the subject's eye during image acquisition. Reflective optical system R7 is selected such that when eye E is within the image capture region defined by the intersection of the field of view region FOV and depth of field region DOF of iris camera IC, an upright virtual image E′ is formed such that the distance between image E′ and eye E is greater than or equal to the near point distance.

As in the case of FIG. 4, in the embodiment illustrated in FIG. 7, reflective optical system R7 may be selected and positioned such that (i) the image capture region defined by the intersection of the filed of view region FOV and the depth of field region DOF of iris camera IC lies between mirror R7 and the focal point of mirror R7, and (ii) to form an upright, magnified virtual image E′ at a distance greater than or equal to the near point distance, from eye E.

While the embodiment illustrated in FIG. 7 shows a concave reflective optical system R7, the reflective optical system may equally take any of the configurations discussed in FIG. 5 or 6. The reflective optical system R7 may alternatively comprise any other reflective optical system (comprising a reflective element or combination of reflective elements and lens elements) configured such that when the subject's eye is positioned in the image capture region defined by the intersection of the field of view and depth of field of the iris camera, which image capture region is at a distance less than the near point distance away from reflective optical system R7, an upright, in-focus image is formed in front of the subject's eye, and at a distance greater than or equal to the near point distance from the subject's eye.

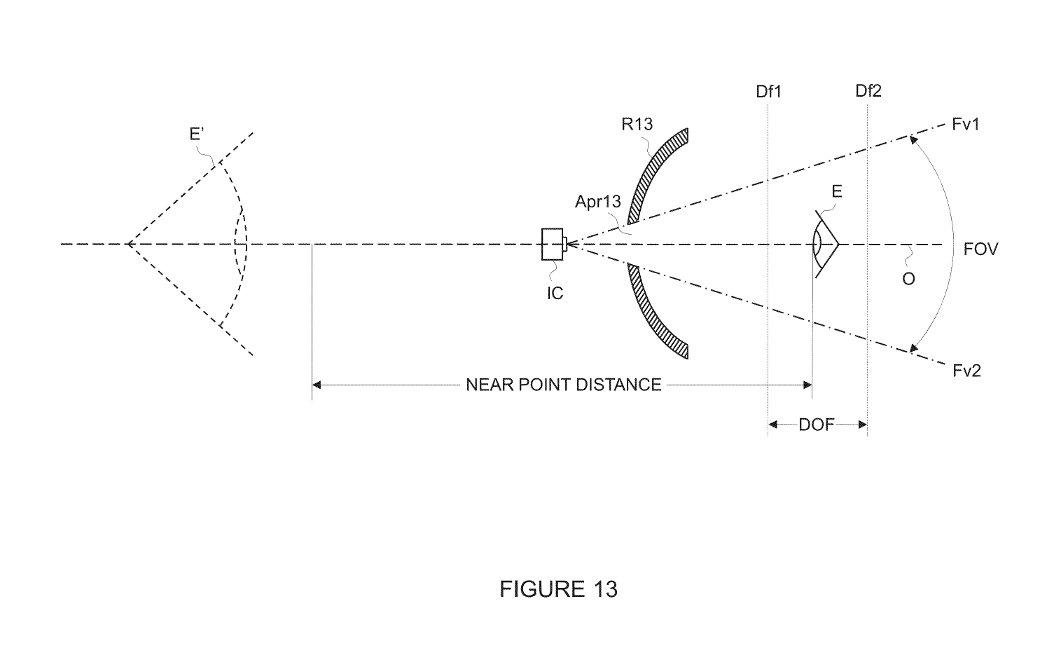

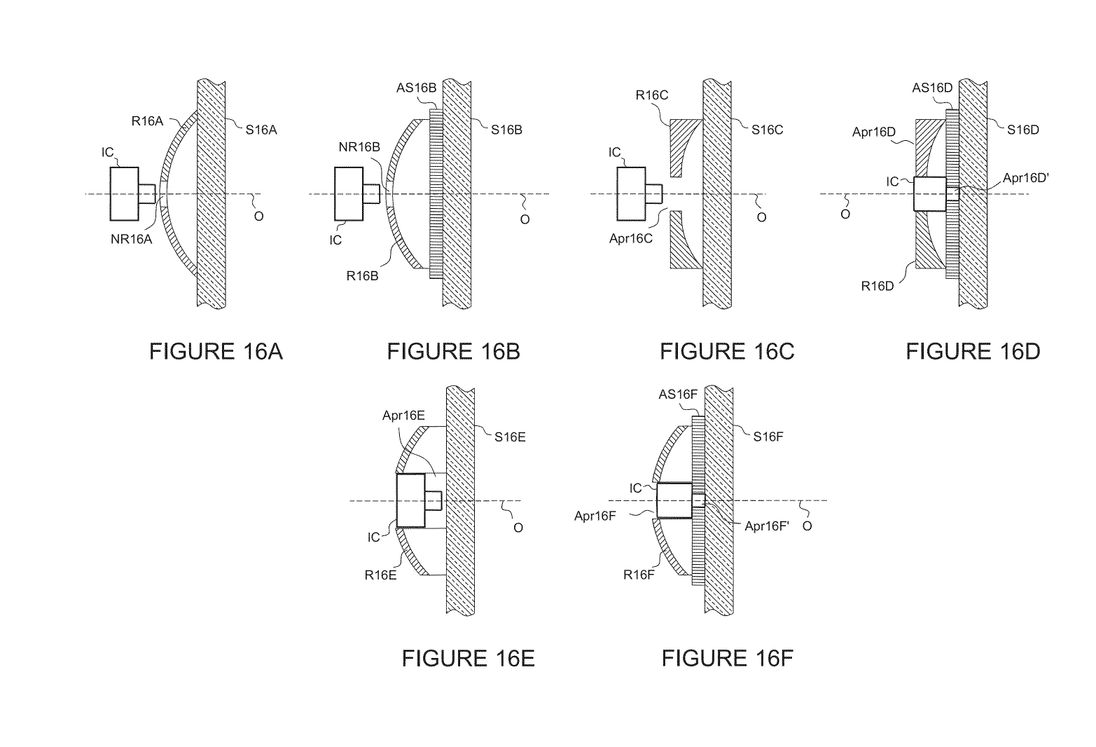

Additionally, while in the embodiment of FIG. 7 reflective optical system R7 comprises a cold mirror or an optical filter, the reflective optical system may alternatively be selected from any one of the configurations illustrated in FIGS. 13 to 16F, which are described in further detail below. In a preferred embodiment, reflective optical system R7 may be selected from among the configurations illustrated in FIGS. 16D and 16E respectively.

The above paragraphs describe specific embodiments of the reflective optical system for obtaining an in-focus reflection of the subject's eye, when the eye is positioned correctly. It would however be understood that the invention is not limited to the specific embodiments discussed and may be implemented through any optical system selected such that, for a desired object distance (the distance at which the subject's eye is intended to be positioned for optimal image capture) which is less than the near point distance, the reflected image of the subject's eye is formed upright, in front of the eye and at a distance at or beyond the near point of the eye.

It would additionally be understood that the reflective optical system may comprise a single unitarily formed element, or may comprise an assembly of optical elements selected and configured for achieving the desired image forming properties.

In a second embodiment of the invention, the feedback object is a real object (and not a reflection of the subject's eye itself). The feedback object may be any object visible to the eye, and disposed to ensure appropriate positioning of the eye and orientation of the iris itself. Without limitation, appropriate feedback objects may include written matter such as text, numerals or characters, illustrations or images, sources of illumination such as an incandescent light or light emitting diode (LED) or any visible two or three dimensional object. The feedback object may be illuminated by ambient light for viewing, or may be illuminated by a dedicated light source, or may be illuminated by light sources from the imaging apparatus itself.

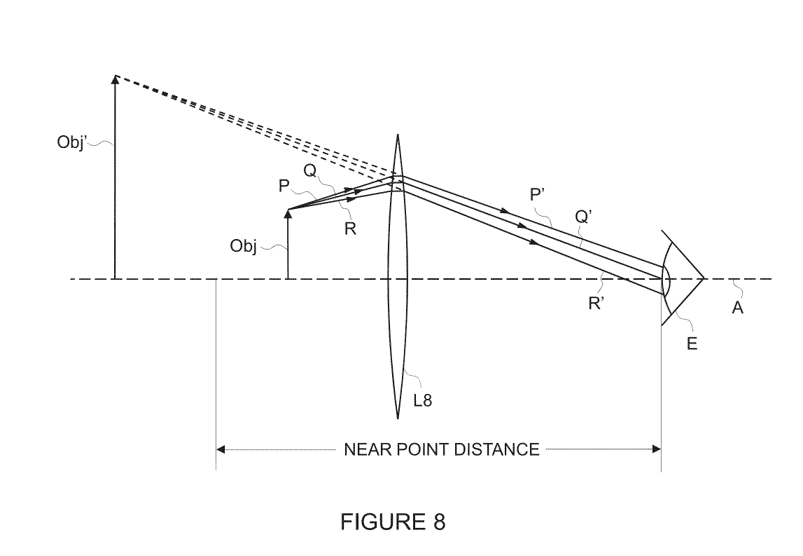

FIG. 8 illustrates the general optical principles relevant to understanding the manner in which a virtual image of a feedback object may be formed beyond the near point distance of the eye, in an embodiment using an optical lens.

In the illustration, incident rays P, Q and R originating from or scattered by object Obj are refracted through lens L8, and are incident upon eye E as rays P′, Q′ and R′. The image location for virtual image Obj′ can be determined by tracing rays P′, Q′ and R′ backwards to where they intersect. For the subject, the refracted rays appear to be diverging from this point, which serves as the image point. By appropriate selection of a lens based on the object distance (the distance between the lens L8 and object Obj) and subject distance (the distance between eye E and lens L8), it can be ensured that virtual image Obj′ is formed in front of the eye and at a distance at or beyond the near point of the eye.

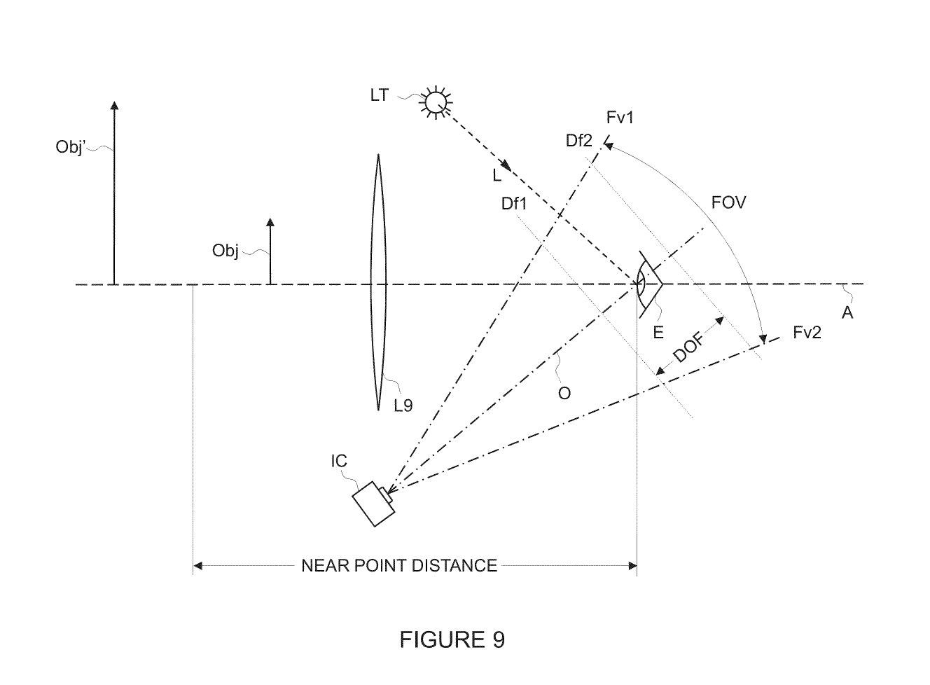

FIG. 9 illustrates a specific embodiment of the invention where the feedback object is a real object. The embodiment comprises iris camera IC and lens element L9, wherein L9 is positioned such that the subject would see an image of object Obj when eye E is within the field of view region FOV. In directing the subject's gaze towards lens element L9 to observe object Obj E, the subject's iris assumes an orientation appropriate for optimal image acquisition by iris camera IC i.e. where the iris is substantially centred along optical axis O of iris camera IC. In certain embodiments, lens element L9 may be positioned such that in viewing virtual image Obj′, the deviation between a direction at which the iris camera is located relative to the eye is between 0° and 30°.

In the illustrated embodiment, the distance between object Obj and eye E is less than the near point distance, and lens element L9 is a convex lens disposed between eye E and object Obj. Lens element L9 is selected such that when eye E is within the field of view region FOV of iris camera IC, an upright, in-focus virtual image Obj′ of object Obj is formed such that the distance between image Obj′ and eye E is greater than the near point distance.

By forming an image at a distance greater than the near point distance of the eye, the subject is enabled to view an in-focus image of the object, when in the appropriate position for image acquisition, despite the physical distance between object Obj and eye E being less than the near point distance.

In the embodiment illustrated in FIG. 9, lens element L9 may be selected so that (i) the object Obj is positioned coincident with or substantially coincident with the front focal plane of lens element L9, or slightly closer to L9 (i.e. the lens element is disposed such that the feedback object lies between the lens element and the front focal plane of the lens element) and (ii) the distance between virtual image Obj′ and eye E is greater than the near point distance.

Selection of an appropriate optical element may be a function of (i) the near point distance (ii) distance between the subject's eye and the optical element, and (iii) distance between the optical element and the feedback object.

The above paragraphs describe the embodiment of the invention in terms of a specific optical element L9 (i.e. a convex lens) for obtaining an upright, in-focus, virtual image of the feedback object, when the subject's eye is positioned correctly for image capture. It would however be understood that the invention is not limited to the specific embodiment discussed and may be implemented through any optical system selected so that, for a desired object distance (the distance between the object Obj and optical element L9, and subject distance (the distance between optical element L9 and subject's eye E when positioned within the field of view FOV of the iris camera, an in-focus virtual image of the feedback object is formed upright, in front of the eye and at a distance at or beyond the near point of the eye. For the purposes of this disclosure, the terms “optical element” and “optical system” shall be understood to be interchangeable.

It would additionally be understood that the optical system may comprise a single unitarily formed element, or may comprise an assembly of optical elements selected and configured for achieving the desired image forming properties.

In an embodiment of the invention where the feedback object is a real object, and an optical system (such as a lens element) is disposed between the subject's eye and the object to project an image of the object beyond the near point distance, an occluder may be incorporated to provide the user with visual feedback regarding correct positioning of the eye.

The occluder contemplated by the invention may include an opaque, translucent or non-transparent structure disposed between the optical element and potential viewing positions of the eye, to partially occlude the virtual image of the feedback object unless the eye is in an optimal position for image capture. The occluder may include a mask (or other opaque or substantially non-transparent element) having an aperture or window provided therein. Non-limiting examples of an occluder involve an annular structure, a slit, pipe, tube, cylinder, keyhole or other structure, having a window or aperture within a substantially non-transparent element such that the window or aperture of the occluder wholly, substantially or partially surrounds the feedback object and allows an unobstructed view of the feedback object from at least one viewing position. Alternatively stated, the occluder may be configured to prevent the subject's eye from partially or fully viewing the feedback object from at least on position outside the image capture region.

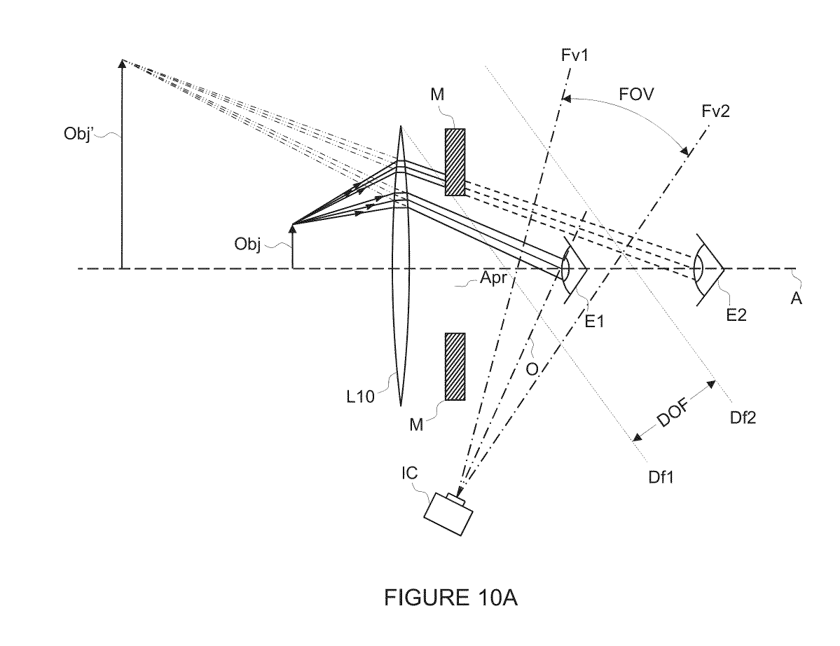

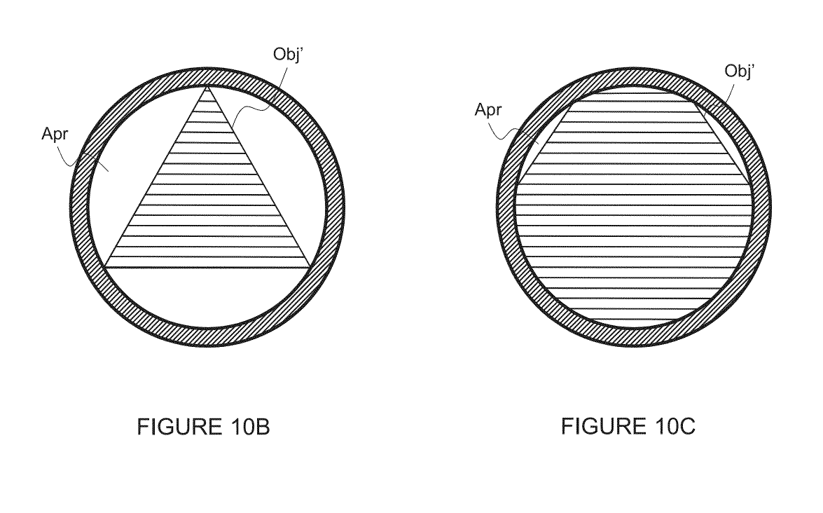

FIG. 10A illustrates a transverse view of the apparatus having convex lens L10 for forming an upright, in-focus, virtual image of the feedback object at a distance beyond the near point distance from the subject's eye, when the subject's eye is positioned correctly for image capture. In the illustrated embodiment, occluder M has an annular structure (defining aperture Apr) and is disposed between convex lens L10 and the image capture region defined by the intersection of the field of view FOV and depth of field DOF. Occluder M is configured to occlude portions of virtual image Obj′ from being viewed by the eye, when the eye is positioned outside (or partially outside) the image capture region.

As illustrated in FIG. 10A, eye E1 is positioned optimally for image capture within field of view FOV of iris camera IC. Optical rays incident from object Obj pass uninterrupted through aperture Apr on the way to eye E1. As described above, selection of lens L10, and its position relative to object Obj and eye E1 ensures that eye E1 sees an in-focus, upright, virtual image Obj′ formed at a distance at or beyond the near point of the eye.

In the same FIG. 10A, eye E2 is positioned beyond the depth of field DOF of iris camera IC. Occluder M accordingly interferes with optical rays incident from the top portion of object Obj and prevents eye E2 from viewing the corresponding top portion of virtual image Obj′. While not illustrated in FIG. 10A, occluder M would similarly interfere with optical rays scattered from other extremities of object Obj and would prevent eye E2 from viewing corresponding extremity portions of virtual image Obj′. It would be understood that eye E2 would only be able to view those portions of virtual image Obj′ that are imaged by rays incident from Obj and which are pass through aperture Apr on their way to eye E2.

FIG. 10B illustrates the entire virtual image Obj′ (a triangle), as seen by eye E1 in the embodiment of FIG. 10A. FIG. 10C illustrates the virtual image Obj′ as seen by eye E2. It will be noted that virtual image Obj′ is only partially visible (the extremity portions of the triangle are occluded) to eye E2—as a consequence of eye E2 being positioned outside the depth of field DOF region of iris camera IC.

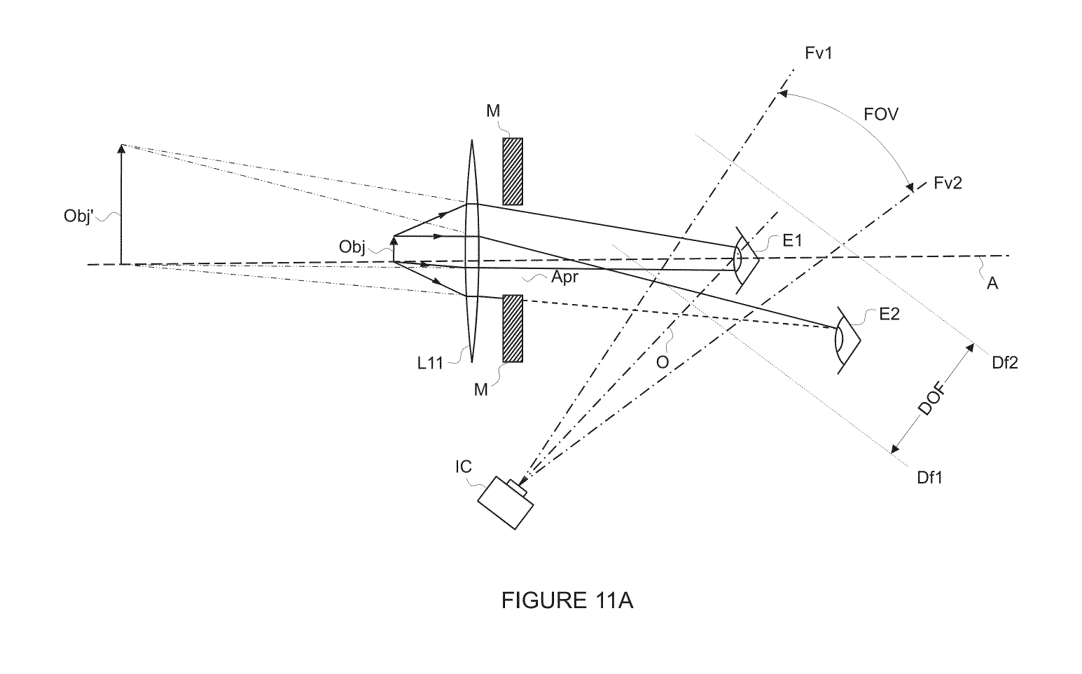

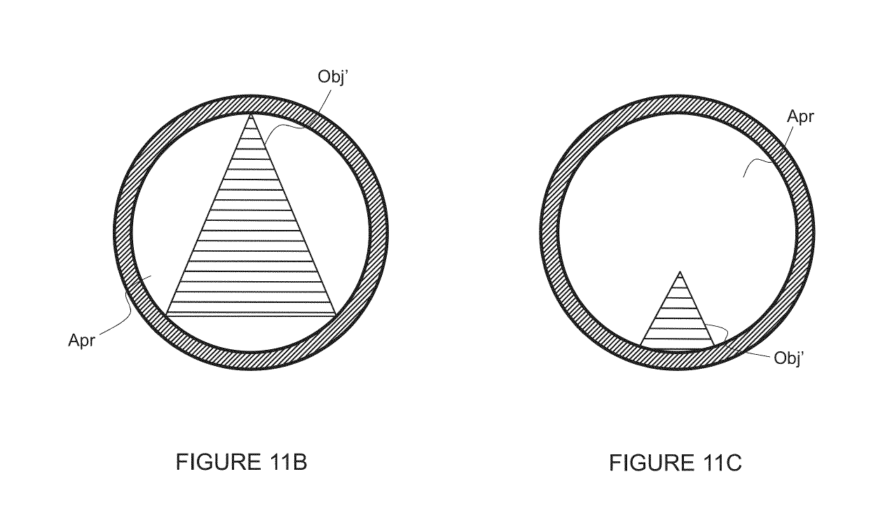

FIG. 11A illustrates a transverse view of the apparatus having convex lens L11 for obtaining an upright, in-focus, virtual image of the feedback object, when the subject's eye is positioned correctly for image acquisition (i.e. within the image capture region defined by the intersection of the field of view FOV and depth of field DOF of iris camera IC). Occluder M having an annular structure (and thereby defining aperture Apr) is disposed between convex lens L11 and the image capture region defined by the intersection of the field of view FOV and depth of field DOF. Occluder M is configured such that it occludes portions of virtual image Obj′ from view of the eye, when the eye is positioned outside (or partially outside) the image capture region.

As illustrated in FIG. 11A, eye E1 is positioned optimally for image capture within the image capture region defined by the intersection of the field of view FOV region and depth of field DOF region of iris camera IC. Optical rays incident from object Obj pass uninterrupted through aperture Apr on their way to eye E1. As described above, selection of lens L11, and its positioning relative to object Obj and eye E1 ensures that eye E1 sees an in-focus, upright, virtual image Obj′ formed at or beyond the near point of the eye.

In the same figure, eye E2 is positioned partially outside the field of view FOV region of iris camera IC. Occluder M accordingly interferes with optical rays incident from the bottom portion of object Obj and prevents eye E2 from viewing the corresponding bottom portion of virtual image Obj′. Eye E2 is only able to view those portions of virtual image Obj′ that are imaged by rays incident from object Obj and which pass through aperture Apr on their way to eye E2.

FIG. 11B illustrates the virtual image Obj′, as seen by eye E1 in the embodiment of FIG. 11A. FIG. 11C illustrates the virtual image Obj′ as seen by eye E2. It will be noted that virtual image Obj′ is only partially visible (having its bottom portion occluded) to eye E2—as a consequence of eye E2 being positioned partially outside the field of view FOV region.

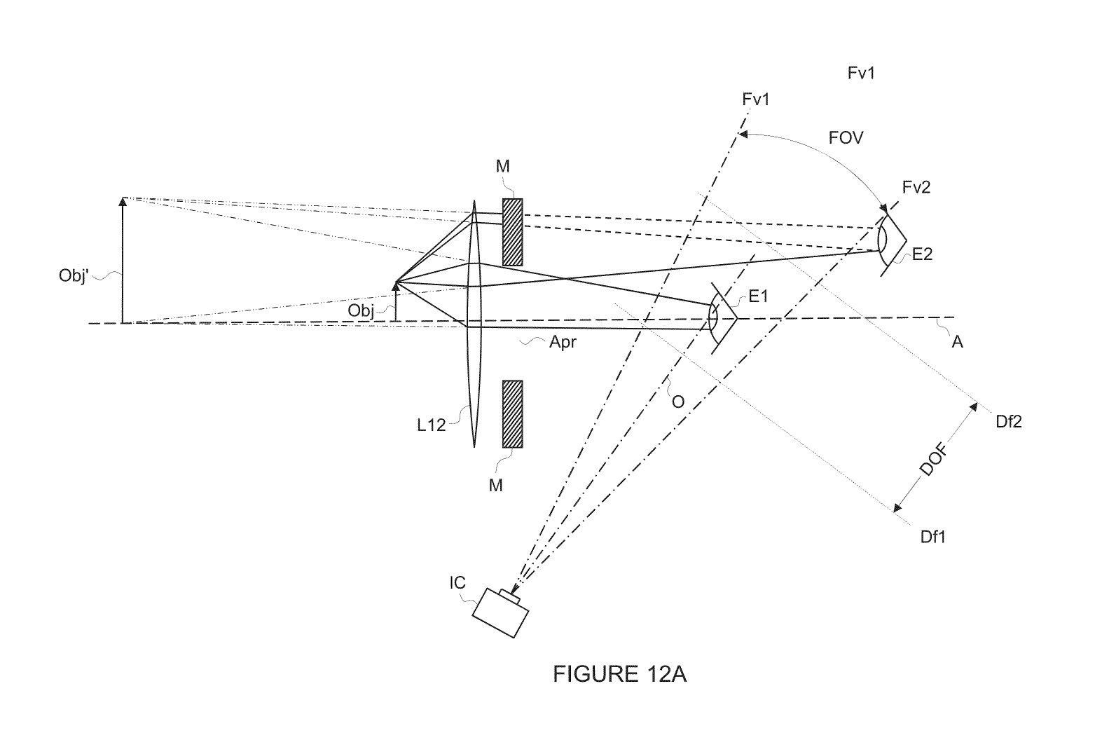

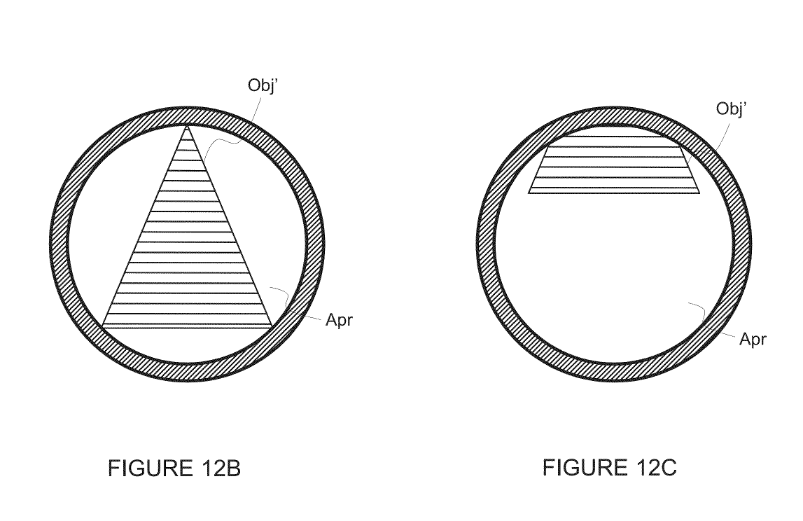

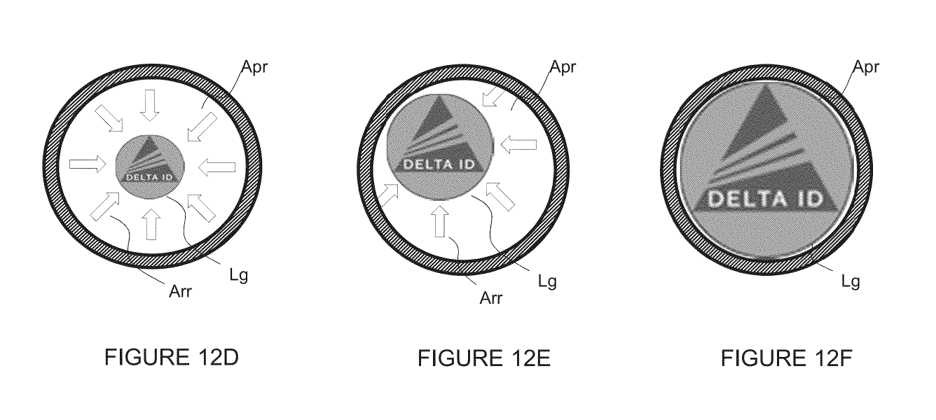

FIG. 12A illustrates a transverse view of the apparatus having convex lens L12 for obtaining an in-focus, virtual image of the feedback object, when the subject's eye is positioned correctly for image capture. Occluder M is configured and positioned to occlude portions of virtual image Obj′ from the subject's eye, if the eye is positioned outside (or partially outside) the image capture region defined by the intersection of the field of view FOV region and depth of field DOF region of iris camera IC.

As illustrated in FIG. 12A, eye E1 is positioned optimally for image capture within the image capture region defined by the intersection of field of view FOV region and depth of field DOF region of iris camera IC. Optical rays incident from object Obj pass uninterrupted through aperture Apr on their way to eye E1. Selection of lens L12, and its positioning relative to object Obj and eye E1 ensures that eye E1 sees an upright, in-focus virtual image Obj′ formed at or beyond the near point of the eye.

In the same figure, eye E2 is positioned partially outside the field of view FOV region of iris camera IC. Occluder M accordingly interferes with optical rays scattered from the top portion of object Obj and prevents eye E2 from viewing the corresponding top portion of virtual image Obj′. Eye E2 can therefore only view portions of virtual object Obj′, that are imaged by rays incident from Obj and which pass through aperture Apr on their way to eye E2.

FIG. 12B illustrates the virtual image Obj′, which would be completely visible to eye E1 in the embodiment discussed in connection with FIG. 12A. FIG. 12C illustrates the virtual image Obj′ that would only be partially visible (having its top portion occluded) to eye E2 as a consequence of positioning the eye outside of field of view FOV region.

FIGS. 12D to 12F illustrate an exemplary embodiment of the invention as more generally discussed in connection with FIGS. 10A to 12C above—i.e. where an optical system (such as a lens element) is disposed between the subject's eye and the object to project an image of the object beyond the near point distance, and having an occluder to provide the user with visual feedback regarding correct positioning.

As shown in FIG. 12D, in the exemplary embodiment the feedback object comprises an icon or logo Lg surrounded by one or more arrows Arr (or other markers) pointing to logo Lg. The arrows Arr draw the subject's eye to the logo Lg.

FIG. 12E illustrates the exemplary embodiment, when the subject's eye is positioned beyond the depth of field DOF of iris camera IC. In this case, the occluder interferes with optical rays incident from a portion of the feedback object and prevents the subject's eye from viewing a portion of the feedback object (in the illustrated embodiment the subject's eye is prevented from viewing arrows in the north-west quadrant of the feedback object), while the remainder of the feedback object (as visible to the subject's eye) is asymmetrically positioned within aperture Apr.

FIG. 12F illustrates the case where the subject's eye is positioned optimally for image capture within the image capture region defined by the intersection of field of view FOV region and depth of field DOF region of iris camera IC. In this case, optical rays incident from the feedback object Obj pass through aperture Apr on their way to the subject's eye such that the entire logo Lg is visible to the subject and is symmetrically positioned within the aperture Apr, while the arrows Arr surrounding logo Lg are not visible to the subject.

While the embodiments disclosed in FIGS. 10A to 12B discuss implementation of an occluding element in combination with a lens element within the optical system, the optical system could equally provide visual feedback regarding correct positioning of the eye, only with an occluder (i.e. without a lens element).

In an embodiment where the optical system relies primarily on an occluder for providing visual feedback, the occluder may be configured and positioned to occlude portions of the feedback object from the subject's eye, if the eye is positioned outside (or partially outside) the field of view region of the iris camera. Optical rays incident from the feedback object would pass uninterrupted through the occluder aperture on their way to the subject's eye only when the eye is positioned within the iris camera's field of view.

In this embodiment, the occluder is configured and positioned to interrupt optical rays incident from the feedback object on their way to regions outside the field of view of the iris camera—thereby occluding at least a portion of the feedback object from the subject's view when the subject's iris is positioned at least partly, or wholly outside the field of view. In a preferred embodiment, the occluder may be configured and positioned such that, responsive to positioning of the subject's iris wholly within the field of view, the feedback object is entirely visible to the subject.

In the same figure, eye E2 is positioned partially outside the field of view FOV region of iris camera IC. Occluder M accordingly interferes with optical rays scattered from the top portion of object Obj and prevents eye E2 from viewing the corresponding top portion of virtual image Obj′. Eye E2 can therefore only view portions of virtual object Obj′, that are imaged by rays incident from Obj and which pass through aperture Apr on their way to eye E2.

FIG. 12B illustrates the virtual image Obj′, which would be completely visible to eye E1 in the embodiment discussed in connection with FIG. 12A. FIG. 12C illustrates the virtual image Obj′ that would only be partially visible (having its top portion occluded) to eye E2 as a consequence of positioning the eye outside of field of view FOV region.

FIGS. 9, 10A, 11A and 12A each illustrate providing a feedback object to ensure positioning of a single eye for imaging. However, the same principles and configuration can be used for positioning or alignment of both eyes of a subject for iris imaging.

In an embodiment, a device or apparatus for positioning or alignment of both eyes may involve duplication of the embodiments illustrated in FIGS. 9, 10A, 11A and 12A to ensure that each eye of the subject is able to view an upright, in-focus, virtual image of the feedback object when that eye is in the correct position for iris imaging.

In one dual eye embodiment of the invention, the virtual image viewed by each eye is independent of the virtual image viewed by the other eye.

In another embodiment of the dual eye embodiment, the two feedback objects or their positioning (or both) are selected so as to provide a single meaningful image to the subject when both eyes are correctly positioned for imaging. In a preferred embodiment, this may be achieved through a stereo pair, wherein the two feedback objects comprise offset images displayed separately to the left and right eye. When both eyes of the subject are in the correct position for iris imaging, the subject sees one image having a perceived depth or three dimensional (3D) effect.

In another dual eye embodiment intended to show a stereo pair, to avoid having to precisely align the two images displayed to the left and right eyes with respect to each other, the two feedback objects include a periodically repeating structure (typically a repeating pattern such as for example, a square grid). The periodical structure enables the subject to see an image having a perceived depth (when both eyes are in the correct position for iris imaging), without requiring configuration of the device or apparatus to ensure precise alignment between the left and right images. In a specific embodiment, the periodically repeating structure has a frequency that is low enough so that the periodic structure is clearly visible and yet high enough so as to provide alignment points close enough so that the eyes can lock on one of them naturally without stress. In a particular embodiment, the periodically repeating structure may comprise medical tape having a grid like repeating pattern. These embodiments serve to eliminate the need for precise alignment between the two optical channels, which may offer manufacturing or cost efficiencies.

As in the case of the embodiment for one eye, the distance between each of the subject's eyes and each of the feedback objects may be less than the near point distance. An optical system is accordingly selected and interposed between each eye and each feedback object such that an upright, in focus virtual image of the feedback object is formed for each eye, such that the distance between the image and the eye is greater that the near point distance.

The invention additionally contemplates an embodiment of the imaging apparatus, where the feedback object is a reflection of the subject's eye itself, and a reflective optical system is disposed between subject's eye E and iris camera IC, along optical axis O. As discussed earlier, prior art implementations of similar apparatuses rely on an optical filter such as a cold mirror or a band-pass filter, which reflects or absorbs selected wavelengths (such as visible wavelengths) but allows certain other wavelengths (such as infrared wavelengths) to pass through to the iris camera. Such filters enable the device to acquire an image of the subject's iris within the infrared region of the radiation spectrum, while simultaneously causing the subject to direct its gaze at the reflection of the eye under imaging, to ensure that the subject's iris is substantially centred at the optical axis of the iris camera.

A drawback of using an optical filter or cold mirror in this manner is the cost of the optical filter—which is significantly higher than the cost of a mirror that reflects both infrared and visible radiations.

With a view to cost efficiencies, the present invention interposes a reflective optical system that reflects visible radiation and may or may not be configured to also reflect any other radiation such as infrared radiation between the subject's eye and the iris camera. In an embodiment, the reflective optical system may comprise an ordinary mirror, which is configured to reflect visible wavelengths while simultaneously allowing sufficient radiation for image acquisition to reach the iris camera.

FIG. 13 illustrates an embodiment of the invention, wherein the feedback object is a reflection of the subject's eye E, and where reflective optical system R13 is disposed between subject's eye E and iris camera IC, along iris camera IC's optical axis O. Reflective optical system R13 is selected to reflect both visible and infrared radiations, and in a preferred embodiment may comprise an ordinary mirrored surface.

Reflective optical system R13 is further provided with aperture Apr13. Aperture Apr13 may in an embodiment, be located at or (substantially at) the centre of the reflective optical system R13. In an embodiment reflective optical system R13 may be positioned such that optical axis O passes through the centre of aperture Apr13. Aperture Apr13 may comprise a hole or discontinuity in the reflective surface of reflective optical system R13.

Reflective optical system R13 may be selected and positioned such that the subject would see an in-focus reflection of its eye E when eye E is within the image capture region defined by the intersection of the field of view FOV region and depth of field DOF region of iris camera IC. While the reflective surface portion of reflective optical system R13 provides the subject with a visual indication regarding positioning of the eye (by reflecting visible radiation back to the subject's eye to form a virtual image E′), aperture Apr13 simultaneously allows radiation scattered off eye E to travel along optical path O and be received at iris camera IC for image acquisition. Depending on the positioning of aperture Apr13, reflective optical system R13 may form an incomplete virtual image E′ of eye E—wherein the reflected image is incomplete as a consequence of radiation that passes through aperture Apr13 and is therefore not reflected back to eye E.

By providing aperture Apr13, the invention uses an ordinary reflective surface to achieve the simultaneous objectives of (i) interposing a reflective optical system between the subject's eye and the iris camera for the purposes of providing a visual indication of correct eye positioning and (ii) allowing sufficient radiation scattered off the subject's eye to be received by an iris camera for image acquisition—thereby avoiding the costs associated with optical filters or cold mirrors.

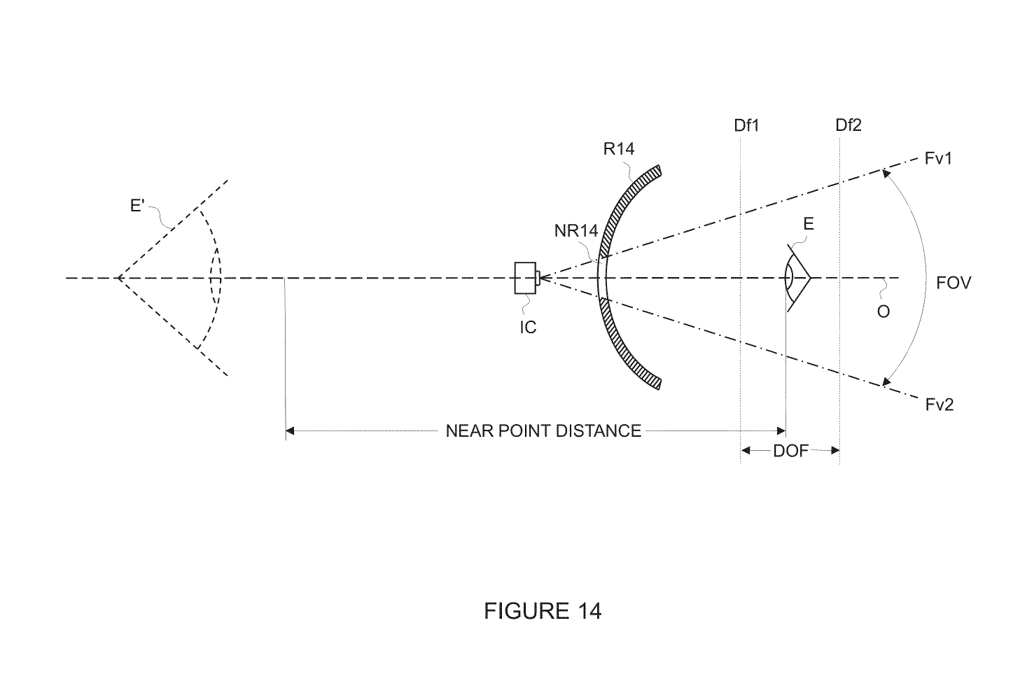

FIG. 14 illustrates another embodiment of the invention, having reflective optical system R14 interposed between the subject's eye E and iris camera IC, which reflective optical system R14 is configured to (i) reflect at least visible radiation and (ii) simultaneously allow radiation sufficient for image acquisition to reach the iris camera.

In the illustrated embodiment, the surface of reflective optical system R14 has non-reflective portion NR14, which non-reflective portion NR14 allows visible and infrared radiations to pass through. The remaining surface of reflective optical system R14 reflects visible and infrared radiations. In a preferred embodiment, the reflective surface of reflective optical system R14 may comprise an ordinary mirrored surface, while non-reflective portion NR14 may comprise a portion of the surface which does not have a mirror coating.

In an embodiment, non-reflective portion NR14 of reflective optical system R14 may be provided at or (substantially at) the centre of the reflective optical system. In a preferred embodiment reflective element R14 may be positioned such that optical axis O passes through the centre of non-reflective portion NR14.

Reflective optical system R14 may positioned such that the subject would see an in-focus reflection of its eye E when positioned within the image capture region defined by the intersection of the field of view FOV region and depth of field DOF region of iris camera IC. While the reflective surface portions of reflective optical system R14 provide the subject with a visual indication of positioning of the eye (by reflecting visible radiation back to the subject's eye to form a virtual image E′ of eye E), non-reflective portion NR14 simultaneously allows sufficient radiation scattered off eye E to travel along optical path O and be received at iris camera IC for the purpose of image acquisition.

Depending on positioning of non-reflective portion NR14 relative to the eye E and iris camera IC, reflective optical system R14 may form an incomplete virtual image E′ of eye E—wherein the reflected image is incomplete as a consequence of radiation that passes through non-reflective portion NR14 en route to iris camera IC and is therefore not reflected back to eye E.

By providing non-reflective portion NR14, the invention may use an ordinary reflective element to achieve the simultaneous objectives of (i) interposing a reflective optical system between the subject's eye and the iris camera for the purposes of providing a visual indication of correct eye positioning and (ii) allowing sufficient radiation scattered off the subject's eye to be received by the iris camera for image acquisition—thereby avoiding the costs associated with optical filters or cold mirrors.

In an embodiment of the invention as illustrated in FIGS. 13 and 14, the position of aperture Apr13 or non-reflective portion NR14 coincides with the virtual image of the pupil of the eye when the iris is correctly positioned within the center of field of view FOV, thereby making aperture Apr13 or non-reflective portion NR14 indistinguishable from the pupil. In an embodiment Apr13 or non-reflective portion NR14 may be specifically sized and positioned within the reflective optical system, so as to coincide with the virtual image of the pupil when the eye is correctly positioned within the centre of field of view FOV. Disappearance of aperture Apr13 or non-reflective portion NR14 may in an embodiment serve as yet further visual feedback that the eye is positioned correctly.

In the embodiments illustrated in FIGS. 13 and 14, reflective optical systems R13 and R14 are concave mirrors. However be understood that any other reflective optical system capable of providing a positive visual indication to the subject when the subject's eye is positioned correctly within the image capture region defined by the intersection of the field of view FOV region and depth of field DOF region of the iris camera IC, would equally suffice for the purposes of a reflective optical system having a reflective and non-reflective portion.

In an embodiment, reflective optical system R13 or R14 may be selected so that when eye E is within the image capture region defined by the intersection of the field of view FOV region and depth of field DOF region of iris camera IC and the distance between eye E and reflective optical system R13 or R14 is less than the near point distance, a virtual image E′ of eye E is formed such that the distance between image E′ and eye E is greater than the near point distance.

In an embodiment of the invention disclosed in FIG. 13 or 14, where the feedback object is a reflection of the subject's eye and the reflective optical system is disposed between subject's eye E and iris camera IC, the reflective optical system may comprise an angle-selective element which may allow the light from the eye to reach the IC. In an embodiment, by choosing an angle-selective reflective element where the surface is reflective only for angles of incidence within the field of view of the iris camera—the subject may only view a reflection of its eye when the eye is correctly positioned within the field of view FOV region. In another embodiment, the angle-selective reflective element may be included only with a view to improving appearance of the device.

In the embodiments illustrated in FIGS. 13 and 14, subject's eye E is shown positioned along optical axis O of iris camera IC, and reflective optical systems R13 and R14 are respectively shown interposed between subject's eye E and iris camera IC, along optical axis O. In alternate embodiments however, the subject's eye E need not be positioned along optical axis O of iris camera IC—and optical elements including mirrors, prisms, or pentaprisms may be used to redirect light scattered off the subject's eye E, onto iris camera IC. In such alternative embodiments, reflective optical systems R13 or R14 may be interposed at an appropriate point along the optical path followed by light scattered off the subject's eye E enroute to the image sensor of iris camera IC.

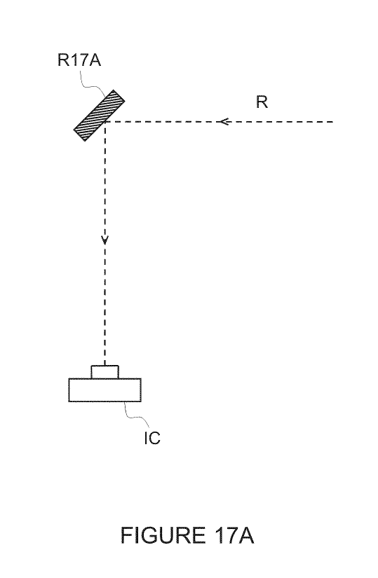

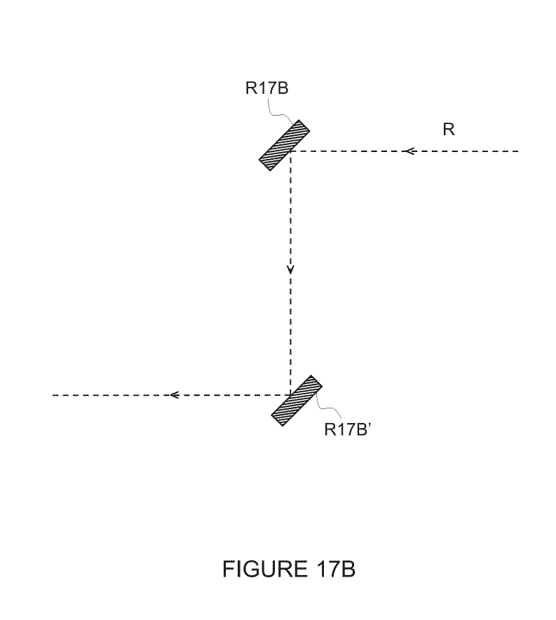

FIG. 17A illustrates an embodiment of an optical element used to redirect light rays onto iris camera IC. In the illustrated embodiment, the optical element is a mirror R17A, positioned and angled such that incident ray R is redirected off the mirror surface and onto iris camera IC. In the illustrated embodiment, redirection of incident ray R causes a folding of the optical path of the incident ray.

FIG. 17B illustrates another embodiment, where a pair of folding mirrors R17B and R17B′ are positioned and angled such that incident ray R is redirected from the original path of the incident ray. In preferred embodiments, optical elements may be used to fold the optical path between the subject's eye and the iris camera which can offer particular advantages when implementing an imaging apparatus within a device with narrow width profiles (such as mobile phones or tablets).

It would be understood that the number of optical elements and their positioning can be varied to appropriately achieve redirection of an incident ray from its original path. Further, instead of mirrors, optical elements may include prisms or any other devices capable of redirecting light rays. Yet further, the application of optical elements to redirect light rays is not limited to the embodiments of FIGS. 13 and 14, and may be used to appropriately configure the optical path of light rays travelling between any two elements within the apparatuses disclosed herein.

It would be understood that alteration of any of the embodiments disclosed in this written description may be appropriately altered by introduction of one or more folding optical elements, without departing from the spirit of the invention. Any embodiment that is equivalent to any of the discussed embodiments when unfolded around one or more folding optical elements, is also covered by this invention.

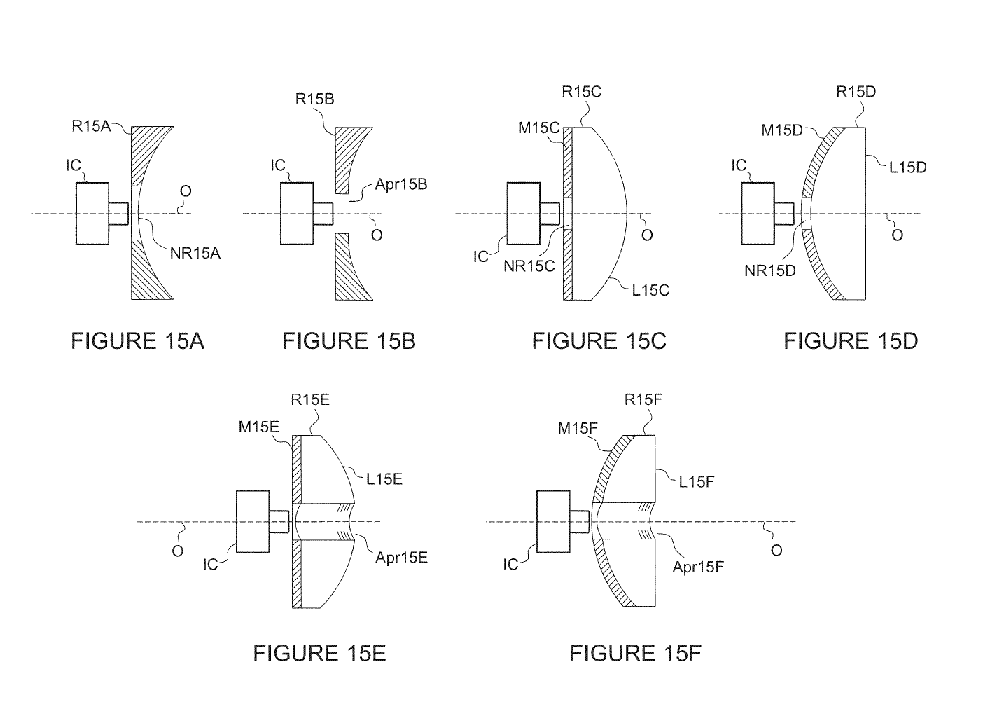

FIGS. 15A to 15F illustrate specific, non-limiting, embodiments of reflective optical systems that may be implemented in connection with FIGS. 13 and 14—i.e. where a reflective optical system is provided with an aperture or a non-reflective portion for allowing radiation scattered off eye E to reach iris camera IC, while simultaneously reflecting visible radiation sufficient to form a virtual image E′ visible to eye E.

FIG. 15A illustrates a reflective optical system R15A having a non-reflective portion NR15A. Non-reflective portion NR15A is, in the illustrated embodiment, located at or substantially at the centre of reflective optical system R15A. Reflective optical system R15A is intended to be positioned relative to iris camera IC such that iris camera IC's optical axis O passes through non-reflective portion NR15A. In the embodiment illustrated in FIG. 15A, reflective optical system R15A is a concave mirror. In one embodiment, concave mirror R15A may be capable of reflecting both visible and infra-red wavelengths.

FIG. 15B shows a reflective optical system R15B having an aperture Apr15B. Aperture Apr15B is, in the illustrated embodiment, located at or substantially at the centre of reflective optical system R15B. Aperture Apr15B is intended to be positioned relative to iris camera IC such that iris camera IC's optical axis O passes through aperture Apr15B. In the embodiment illustrated in FIG. 15B, reflective optical system R15B is a concave mirror. In one embodiment, concave mirror R15B may be capable of reflecting both visible and infra-red wavelengths.

FIG. 15C illustrates a reflective optical system R15C having a non-reflective portion NR15C. Non-reflective portion NR15C is, in the illustrated embodiment, located at or substantially at the centre of reflective optical system R15C. Reflective optical system R15C is intended to be positioned relative to iris camera IC such that iris camera IC's optical axis O passes through non-reflective portion NR15C. In the embodiment illustrated in FIG. 15C, reflective optical system R15C is a plano-convex mirror element having flat reflective element M15C disposed proximal to iris camera IC and convex lens element L15C disposed distal to iris camera IC. Non-reflective portion NR15C may be achieved by having a non-coated or non-reflective surface portion of reflective element M15C.

FIG. 15D illustrates a reflective optical system R15D having a non-reflective portion NR15D. Non-reflective portion NR15D is, in the illustrated embodiment, located at or substantially at the centre of reflective optical system R15D. Reflective optical system R15D is intended to be positioned relative to iris camera IC such that iris camera IC's optical axis O passes through non-reflective portion NR15D. In the embodiment illustrated in FIG. 15D, reflective optical system R15D is a plano-convex mirror element having convex reflective element M15D disposed proximal to iris camera IC and planar lens portion L15D disposed distal to iris camera IC. Non-reflective portion NR15D may be achieved by having a non-coated or non-reflective surface portion of reflective element M15D.

FIG. 15E shows a reflective optical system R15E having an aperture Apr15E. Aperture Apr15E is, in the illustrated embodiment, located at or substantially at the centre of reflective optical system R15E. Aperture Apr15E is intended to be positioned relative to iris camera IC such that iris camera IC's optical axis O passes through aperture Apr15E. In the embodiment illustrated in FIG. 15E, reflective optical system R15E is a plano-convex mirror element having flat reflective element M15E disposed proximal to iris camera IC and convex lens element L15E disposed distal to iris camera IC.

FIG. 15F shows a reflective optical system R15F having an aperture Apr15F. Aperture Apr15F is, in the illustrated embodiment, located at or substantially at the centre of reflective optical system R15F. Aperture Apr15F is intended to be positioned relative to iris camera IC such that iris camera IC's optical axis O passes through aperture Apr15F. In the embodiment illustrated in FIG. 15F, reflective optical system R15F is a plano-convex mirror element having convex reflective element M15F disposed proximal to iris camera IC and planar lens portion L15F disposed distal to iris camera IC.

FIGS. 16A to 16F illustrate particular, non-limiting embodiments of reflective optical systems more generally described in connection with FIGS. 13 and 14, when disposed within a device housing having an external surface (such as a front surface of a mobile phone, laptop or tablet). In a preferred embodiment, the external surface of the device housing may be optically clear (or transparent) or substantially optically clear (or substantially transparent). In the illustrated embodiments, the reflective optical system and iris camera are both disposed within the device housing and adjoining (or substantially adjoining) the external surface of the housing.

FIG. 16A illustrates the reflective optical system and iris camera as discussed above in connection with FIG. 15A, wherein reflective optical system R16A is a concave mirror and has a non-reflective portion NR16A. Reflective optical system R16A is in the illustrated embodiment disposed adjoining (or substantially adjoining) flat surface S16A of a housing, which flat surface is transparent or otherwise configured to allow transmission of visible and infra-red wavelengths therethrough. In a preferred embodiment, reflective optical system R16A is placed flush against flat surface S16A for space efficiencies, which presents advantages when implementing the invention within devices having narrow width profiles (such as mobile phones or tablets).

FIG. 16B illustrates a preferred embodiment of the invention more generally discussed in connection with FIG. 16A. The preferred embodiment further includes an angle-selective reflective element AS16B disposed between the reflective optical system R16B and flat surface S16B.

FIG. 16C illustrates the reflective optical system and iris camera as discussed in connection with FIG. 15B, wherein reflective optical system R16C is a concave mirror and has an aperture Apr16C. Aperture Apr16C is further sized such that iris camera IC (or a portion thereof) may be located or housed within the aperture. Reflective optical system R16C is in the illustrated embodiment disposed adjoining (or substantially adjoining) flat surface S16C of a housing, which flat surface is transparent or otherwise configured to allow transmission of visible and infra-red wavelengths therethrough. In a preferred embodiment, reflective optical system R16C is placed flush against flat surface S16C for space efficiencies.

FIG. 16D illustrates a preferred embodiment of the invention more generally discussed in connection with FIG. 16C. The preferred embodiment further includes an angle-selective reflective element AS16D disposed between the reflective optical system R16D and flat surface S16D. As illustrated in FIG. 16D, the aperture Apr16D within reflective optical system R16D is sized to house iris camera IC therewithin. In the embodiment of the invention illustrated in FIG. 16D, angle-selective reflective element AS16D additionally has an aperture Apr16D′ configured and sized to house at least a portion of iris camera IC therewithin. By placing (i) the flat surface of the housing, (ii) the angle-selective reflective element and (iii) the reflective optical system adjacent to each other and providing apertures for housing portions of the iris camera within the reflective optical system and the angle-selective reflective element, the invention offers significant space efficiencies that reduce the device size or width profile.

FIG. 16E illustrates the reflective optical system and iris camera as discussed in connection with FIG. 15D, wherein reflective optical system R16E is a plano-convex element. In the illustrated embodiment convex reflective portion of reflective optical system R16E is located distal to flat surface S16E of the device housing, while the planar lens portion of reflective optical system R16E is disposed proximal to flat surface S16E. Aperture Apr16E is further sized such that iris camera IC (or a portion thereof) may be located or housed within the aperture. Flat surface S16E may be transparent or otherwise configured to allow transmission of visible and infra-red wavelengths therethrough. In a preferred embodiment, reflective optical system R16E is placed flush against flat surface S16E for space efficiencies.

FIG. 16F illustrates a preferred embodiment of the invention as discussed in connection with FIG. 16E. The preferred embodiment further includes an angle-selective reflective element AS16F disposed between the reflective optical system R16F and flat surface S16F. As illustrated in FIG. 16F, aperture Apr16F within reflective optical system R16F is sized to house iris camera IC therewithin. In the embodiment of the invention illustrated in FIG. 16F, angle-selective reflective element AS16F additionally has an aperture Apr16F′ configured and sized to house at least a portion of iris camera IC therewithin.

In an embodiment of the invention, where the distance between the subject's eye and a feedback object is less than the near point distance, and an optical element forms an image of the feedback object at a distance greater than or equal to the near point distance, away from the eye, selection of an appropriate optical element may be a function of (i) the near point distance and (ii) the distance between the subject's eye and the optical element, when the subject's eye is within the depth of field region of the iris camera. In a particular embodiment of the invention, where the feedback object is not a reflection of the subject's eye, selection of the optical element is additionally a function of the distance between the optical element and the feedback object.

In a preferred embodiment, the focal length of the optical system is selected (approximately) according to the thin lens formula:

$$\frac{1}{F} = \frac{1}{U} + \frac{1}{V}$$

wherein
F=focal distance of the optical element,
U=object distance, and
V=image distance.

In a first implementation of the thin lens formula, involving a reflective element for forming an image of the feedback object:
(i) the object distance U is the distance between the subject's eye and the optical element, when the subject's eye is within the depth of field of the iris camera; and
(ii) the image distance V is a distance greater or equal to the distance between the near point of the eye and the object distance U, when the subject's eye is within the depth of field of the iris camera.
   The thin lens formula may thereafter be applied, enabling selection of a reflective element having focal distance F.

In another implementation of the thin lens formula, involving a lens element for forming an image of the feedback object:
(i) the object distance U is the distance between the feedback object and the optical element, and
(ii) the image distance V is the distance greater or equal to the distance between the near point of the eye and the optical element, when the subject's eye is within the depth of field of the iris camera.
   The thin lens formula may thereafter be applied to enable selection of a lens element having an appropriate focal distance F.

It would be understood that the thin lens formula assumes an optical element having a negligible thickness. For implementations of the invention involving imaging apparatuses disposed within devices with narrow profiles, such as for example mobile phones, smart phones, tablets or other handheld communication devices, the narrow profile of the imaging device necessitates use of optical elements of correspondingly insignificant thicknesses—thereby ensuring appropriateness of the thin lens formula for selecting an appropriate optical system.

It would however be understood that the thin lens formula may be modified appropriately to account for lenses having significant thicknesses as well.

Equally, the present invention contemplates implementation of other functions which enable calculation of focal length for the optical element, based on the variables discussed above.

The invention further contemplates a kit for assembling an apparatus for enabling correct positioning of an iris for image capture, wherein the apparatus uses a feedback object located such that the distance between the feedback object and the position of a subject's eye during image acquisition is less than the near point distance of the eye.

The kit of the present invention includes at least a camera having an image sensor, and an optical system. The camera of the kit has a field of view FOV region and a depth of field DOF region for iris image acquisition, the intersection of which regions determines the appropriate location of a subject's iris for image acquisition with sufficient sharpness and detail. In an embodiment, the image capture distance of the camera is less than 25 cm, and in preferred embodiments of the invention may be less than 12.5 cm.

The optical system is selected based on (i) a first point coinciding with the location at which a feedback object is intended to be provided and (ii) a second point coinciding with the location at which the subject's eye is intended to be positioned when it is within the image capture region defined by the intersection of the field of view and depth of field of the camera.

The optical system of the kit is selected to have a focal length that is a function of (i) the near point distance and (ii) distance between the second point and the intended position of the optical system during image acquisition.

In a particular embodiment of the invention, selection of the optical system is additionally a function of (i) the distance between the first point and (ii) the intended position of the optical system during image acquisition.

Selection of the optical system in the above manner ensures that when the distance between the subject's eye and the feedback object is less than the near point distance, interposing the optical element between the first point and second point causes an image of the feedback object to be formed upright, in front of the subject's eye and at a distance at or beyond the near point of the eye.

The optical system of the kit may be selected or configured according to any of the specific methods for selection thereof, as discussed above. It would be additionally understood that the selected optical system may comprise either a reflective element or a lens element (or a combination thereof), including without limitation, any of the specific embodiments of optical systems, reflective optical systems, reflective elements or lens elements previously discussed.

In an embodiment of the invention, where the feedback object is intended to be a reflection of the subject's eye itself, the reflective optical system may comprise an angle-selective reflective element. In an embodiment, the angle-selective reflective element may be configured such that the surface of such reflective element is reflective only within angles of incidence that correspond with the field of view of the iris camera—thereby ensuring that the subject will only be able to view a reflection of its eye when positioned within the field of view of the camera. In another embodiment, the angle-selective reflective element may be included only with a view to improving appearance of the device.

In a preferred embodiment, the optical system of the kit may comprise a reflective optical system configured for being interposed between the iris camera and the second point, such that the subject sees an upright, in-focus image of the feedback object when the eye intended for imaging is positioned at the second point.

In certain embodiments, the reflective optical system interposed between the iris camera and the second point may (i) comprise an optical filter, band-pass filter, or cold mirror capable of selectively reflecting radiation of certain wavelengths, or (ii) have a aperture or a non-reflective clear portion to allow radiation scattered off the subject's iris to reach the iris camera for image acquisition, while simultaneously providing a reflection of a portion of the subject's eye as a visual indication of positioning of the eye.

In an embodiment of the invention where the feedback object is a real object, and a lens element is disposed between the first point and the second point, the kit may include an occluder structure (such as an opaque, translucent or non-transparent mask) which may be disposed between the optical system and potential viewing positions of the eye, and positioned to partially occlude the image of the feedback object from being viewed unless the eye is in the optimal position for image capture. The occluder may include a mask (or other opaque or substantially non-transparent element) having an aperture or window provided therein. Non-limiting examples of an occluder involve an annular structure, a slit, pipe, tube, cylinder, keyhole or other structure, having a window or aperture within a substantially non-transparent element such that the window or aperture of the occluder wholly, substantially or partially surrounds the feedback object and allows an unobstructed view of the feedback object from at least one viewing position.

The kit may additionally comprise at least one feedback object comprising any real object (including without limitation numerals, characters, text, illustrations, images or sources of illumination) discussed above. In another embodiment, the kit may further include a display for generating a feedback object at the first point, which display may be mechanical, electrical or electronic (including by way of example, electronic screens, visual display units, LED displays, or screens backed by a light source).

In a specific embodiment, the kit may include at least one illumination source for scattering light off either a subject's eye or off a feedback object to enable the subject to view a virtual image of its eye or of the feedback object for positioning of the eye. In an embodiment, this illumination source may generate radiations having visible wavelengths, and may comprise an LED capable of generating visible radiation or an incandescent light source.

In another embodiment, the kit may include at least one illumination source for scattering light off the subject's eye for the purpose of image acquisition by the camera. In an embodiment, this illumination source may generate radiations having infrared wavelengths, and may comprise an LED capable of generating infrared radiation, or an incandescent lamp.

In a preferred embodiment the kit consists of a single illumination source intended for the dual purposes of providing visible radiation to enable a subject to view the feedback object and providing infrared radiation to enable image acquisition by the camera. In an embodiment, this single illumination source may comprise an incandescent light source.

The kit may include fasteners for fixedly or removably interposing the optical system between the first point and second point. In an embodiment, the kit may include a casing or shell capable of interposing the optical system between the camera and the second point.

In an embodiment of the invention, the camera of the kit is a camera disposed within a handheld communication device or a mobile computing device, such as a mobile phone, smart phone, personal digital assistant, tablet or laptop device.

The invention additionally minimizes or compensates for the rotation of the iris around the optical axis of the iris camera between the two images being compared.

As discussed previously, subjects tend to naturally position their heads, and consequently their irises, in a substantially vertical orientation (i.e. without significant angular deviation relative to the horizontal and vertical axes) in anticipation of image capture, and more particularly during iris image capture. Rotational deviations between the subject's iris and the iris camera and thus between the two images being compared therefore tend to arise as a consequence of inadvertent tilt of the iris camera.

The invention addresses this problem by detecting through a deviation sensor, deviations between a current orientation of the iris camera and a predetermined optimal orientation for the iris camera, and thereafter, responsive to a detected deviation effecting a correction to compensate for the detected deviation.

In an embodiment, the invention uses a sensor for detecting tilt of the iris camera—which tilt is measured as angular deviation of the image sensor relative to the horizontal and vertical axes. In the event the sensor detects and measures the degree of rotation of the camera or of the device comprising the camera around the optical axis of the camera. Based on the measured rotation one or more of the following actions can be taken:
a. Subject can be guided to rotate the camera until an optimal orientation for image capture is achieved, prior to allowing image capture
b. Compensate for the detected rotation by rotating the image
c. Record the rotation with the image to be used to determine relative rotation between the two images during comparison, where the comparison function can compensate for it.

The sensor for detecting tilt may comprise an accelerometer, gyroscope, tilt sensor or any other device or mechanism capable of detecting angular deviation of an object relative to at least the horizontal and vertical axes.

In a particular embodiment of an imaging apparatus, an illumination source may be provided for directing visible or infrared radiation on to the subject's iris, which radiation is scattered off the iris and received at the image sensor for image acquisition. It would be understood that the illumination source may be located in any position that enables illuminating radiation to be directed onto the subject's iris so that it is scattered and thereafter received at an image sensor. In a preferred embodiment however, the illumination source should be located alongside or below the camera to prevent creation of shadows by the eyebrows.

In this preferred embodiment, the illumination source may comprise a LED or other light source located horizontally adjacent to or anywhere below a lens through which radiation is incident upon the imaging sensor. In an embodiment of the invention, the sensor for detecting tilt of the imaging sensor may be configured to alert the subject if the imaging apparatus has been rotated so that the illumination source is now positioned higher than the lens through which radiation is incident upon the image sensor. The subject may respond to such alerts by rotating the imaging device in the x-y plane to ensure that at the time of image acquisition, the illumination source is positioned adjacent to or below the lens through which radiation is incident upon the image sensor.

In a particular embodiment, the method for minimizing or eliminating rotational deviation between a subject's iris and an image sensor is implemented using a device having a camera and a sensor for detecting tilt. Since handheld communication devices and mobile computing devices, including mobile phones, smart phones, personal digital assistants, tablets and laptop devices are provided with both cameras and accelerometers or other tilt sensors, the method may be implemented using any such devices.

In one embodiment, the method serves to correct tilt of an iris imaging apparatus during iris image capture—wherein the iris imaging apparatus includes at least an iris camera and a deviation sensor. The method detects through a deviation sensor, deviations between an orientation of the iris camera and a predetermined optimal orientation for the iris camera. Responsive to a detected deviation, a correction is effected to tilt of the iris camera.

In one embodiment of the method, the predetermined optimal orientation for the iris camera comprises alignment or substantial alignment of a reference plane within the iris camera, along a vertical plane. In another embodiment of the method, the predetermined optimal orientation for the iris camera is an orientation where the iris camera is aligned or substantially aligned along the horizontal and vertical axes respectively. In such embodiment, the detected deviations from a predetermined optimal orientation consists of angular deviations of the iris camera relative to at least the horizontal and vertical axes.

In another embodiment, the predetermined optimal orientation of the iris camera comprises alignment or substantial alignment of a reference plane within the iris camera with a plane defined by a gravity field gradient and an axis perpendicular to the gravity field gradient. In such embodiment, the detected deviations from a predetermined optimal orientation consists of angular deviations of the reference plane of the iris camera relative to at least the gravity field gradient and to the axis perpendicular to the gravity field gradient. In one embodiment, a plane within which an image sensor of the iris camera is disposed serves as a reference plane.

Responsive to the detected angular deviations relative to the horizontal and vertical axes, tilt of the iris camera may be corrected by effecting a correction to the measured angular deviations. In one embodiment, tilt of the iris camera is corrected by alerting an operator to reduce angular deviations of the iris camera relative to the horizontal and vertical axes. In another embodiment, tilt of the iris camera may be corrected by rotating an iris image acquired by the iris camera sufficiently to compensate for the measured angular deviations relative to the horizontal and vertical axes. In a specific embodiment, the deviation sensor may comprise an accelerometer or a tilt sensor.

In another specific embodiment of the method, the iris imaging apparatus may additionally include an illumination source, and the iris camera may comprise an image sensor and a camera lens. In such embodiments, deviations may be identified corresponding to any orientation of the iris imaging apparatus where the camera lens is positioned lower than the illumination source.

In addition to the apparatus and device limitations of the invention disclosed hereinabove, the invention additionally includes methods for configuring an iris imaging apparatus and for correcting tilt of an iris imaging apparatus during iris image capture, in accordance with the disclosure hereinabove.

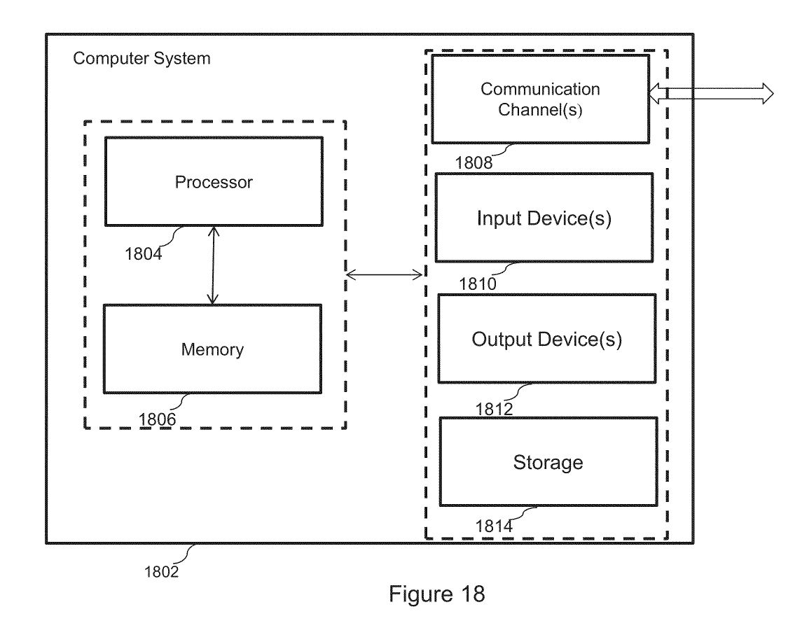

FIG. 18 illustrates an exemplary computer system in which various embodiments of the invention may be implemented.

The computer system 1802 comprises at-least one processor 1804 and at-least one memory 1806. The processor 1804 executes program instructions and may be a real processor. The processor 1804 may also be a virtual processor. The computer system 1802 is not intended to suggest any limitation as to scope of use or functionality of described embodiments. For example, the computer system 1802 may include, but not limited to, one or more of a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 1806 may store software for implementing various embodiments of the present invention. The computer system 1802 may have additional components. For example, the computer system 1802 includes one or more communication channels 1808, one or more input devices 1810, one or more output devices 1812, and storage 1814. An interconnection mechanism (not shown) such as a bus, controller, or network, interconnects the components of the computer system 1802. In various embodiments of the present invention, operating system software (not shown) provides an operating environment for various softwares executing in the computer system 1802, and manages different functionalities of the components of the computer system 1802.

The communication channel(s) 1808 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 1810 may include, but not limited to, a touch screen, a keyboard, mouse, pen, joystick, trackball, a voice device, a scanning device, or any another device that is capable of providing input to the computer system 1802. In an embodiment of the present invention, the input device(s) 1810 may be a sound card or similar device that accepts audio input in analog or digital form. The output device(s) 1812 may include, but not limited to, a user interface on CRT or LCD, printer, speaker, CD/DVD writer, or any other device that provides output from the computer system 1802.

The storage 1814 may include, but not limited to, magnetic disks, magnetic tapes, CD-ROMs, CD-RWs, DVDs, flash drives or any other transitory or non-transitory medium which can be used to store information and can be accessed by the computer system 1802. In various embodiments of the present invention, the storage 1814 contains program instructions for implementing the described embodiments.

In an embodiment of the present invention, the computer system 1802 is part of a distributed network where various embodiments of the present invention are implemented for rapidly developing end-to-end software applications.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1802. The method described herein is typically implemented as a computer program product, comprising a set of program instructions which is executed by the computer system 1802 or any other similar device. The set of program instructions may be a series of computer readable codes stored on a tangible medium, such as a computer readable storage medium (storage 1814), for example, diskette, CD-ROM, ROM, flash drives or hard disk, or transmittable to the computer system 1802, via a modem or other interface device, over either a tangible medium, including but not limited to optical or analogue communications channel(s) 1808. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. An iris imaging apparatus for acquiring an image of a subject's iris, comprising:
an iris camera comprising an image sensor, and configured to have an image capture region defining an intended position of the subject's iris for iris image capture; and
an optical system comprising a reflective element disposed such that, responsive to positioning of the subject's iris within the image capture region, the optical system forms a subject viewable in-focus upright image of the subject's iris;
wherein length of an optical path between the intended position of the subject's iris during image capture and the reflective element is less than half of a near point distance, the near point distance defining a shortest distance from an eye at which an object is capable of in-focus viewing by the eye, and
wherein a distance between the image capture region and the in-focus upright image formed by the optical system is greater than or equal to the near point distance.

2. The iris imaging apparatus as claimed in claim 1, wherein the near point distance is 25 cm.

3. The iris imaging apparatus as claimed in claim 1, wherein a distance between the image capture region and the image sensor is less than half the near point distance.

4. The iris imaging apparatus as claimed in claim 3, wherein the reflective element is an optical element configured to reflect at least some visible wavelengths while allowing passage of at least some infrared wavelengths onward to the iris camera.

5. The iris imaging apparatus as claimed in claim 1, wherein the reflective element is positioned to one side of the iris camera, such that the reflective element is entirely removed from an optical axis of the iris camera.

6. The iris imaging apparatus as claimed in claim 5, comprising a substantially transparent plano-parallel element disposed between (i) the image capture region and (ii) the reflective element and the iris camera,
wherein deviation between the iris camera's lens axis and an axis perpendicular to the plano-parallel element, is between 0° and 5°.

7. The iris imaging apparatus as claimed in claim 1, wherein the reflective element is disposed such that in viewing the in-focus upright image of the subject's iris, either the subject's eye is looking in a direction of the iris camera, or deviation between a direction in which the subject's eye is looking and the direction of the iris camera is between 0° and 30°.

8. The iris imaging apparatus as claimed in claim 1, wherein the reflective element is selected and positioned such that the image capture region lies between the reflective element and focal point of the reflective element.

9. The iris imaging apparatus as claimed in claim 1, wherein the reflective element is an angle selective reflective element configured to reflect incident light only at predetermined angles of incidence.

10. The iris imaging apparatus as claimed in claim 1, having a smart glass element disposed between the reflective element and the image capture region.

11. The iris imaging apparatus as claimed in claim 1, wherein the reflective element is a smart glass reflective element.

12. The iris imaging apparatus as claimed in claim 1, wherein the reflective element is one of a concave, plano-convex, or plano-concave reflective element.

13. The iris imaging apparatus as claimed in claim 1, wherein configuration of the optical system is based on (i) the near point distance and (ii) distance between the reflective element and the intended position of the subject's iris during image capture.

14. The iris imaging apparatus as claimed in claim 1, wherein the distance between the subject's iris and the reflective element is less than 12.5 cm.

15. The iris imaging apparatus as claimed in claim 1, wherein the reflective element has a reflective portion and a non-reflective portion, such that:
the reflective portion reflects at least some visible wavelength radiation scattered from the subject's iris when the subject's iris is positioned within the image capture region; and
the non-reflective portion allows at least some radiation scattered from the subject's iris when the subject's iris is positioned within the image capture region, to pass through the reflective element and on to the image sensor for image acquisition.

16. The iris imaging apparatus as claimed in claim 15, wherein the non-reflective portion comprises at least one of a hole through the reflective element or a discontinuity in a reflective surface of the reflective element.

17. The iris imaging apparatus as claimed in claim 15, wherein the non-reflective portion allows passage of visible wavelength radiation and infrared wavelength radiation through the reflective element and on to the image sensor for image acquisition.

18. The iris imaging apparatus as claimed in claim 15, wherein the reflective portion additionally reflects infrared wavelength radiation.

19. The iris imaging apparatus as claimed in claim 15, wherein the reflective portion comprises a mirror surface.

20. The iris imaging apparatus as claimed in claim 15, wherein the reflective element is positioned such that optical axis of the iris camera passes through the non-reflective portion.

21. The iris imaging apparatus as claimed in claim 15, wherein the non-reflective portion defines a non-reflective aperture at a center of the reflective element.

22. The iris imaging apparatus as claimed in claim 15, wherein the reflective element is positioned such that, responsive to positioning of the subject's iris within the image capture region, the non-reflective portion of the reflective element coincides with location of the subject's pupil in the image formed by the reflective element.

23. The iris imaging apparatus as claimed in claim 15, wherein the reflective element comprises one of a concave reflective element, a plano-convex reflective element having a flat reflective surface disposed proximal to the iris camera and a convex lens surface disposed distal to the iris camera, or a plano-convex reflective element having a convex reflecting surface disposed proximal to the iris camera and a planar lens surface disposed distal to the iris camera.

24. The iris imaging apparatus as claimed in claim 15, wherein the non-reflective portion comprises an aperture in the reflective element, said aperture configured and sized to house at least a portion of the iris camera therewithin.

25. The iris imaging apparatus as claimed in claim 15, wherein the apparatus is disposed within a device housing having a substantially transparent surface.

26. A method of configuring an iris imaging apparatus for acquiring an image of a subject's iris, the method comprising:
configuring an iris camera comprising an image sensor, to have an image capture region defining an intended position of the subject's iris during image capture; and
positioning an optical system comprising a reflective element such that, responsive to positioning of the subject's iris within the image capture region, the optical system forms a subject viewable in-focus upright image of the subject's iris;
wherein a distance between the image capture region and the reflective element is less than half a near point distance, the near point distance defining a shortest distance from an eye at which an object is capable of in-focus viewing by the eye, and
wherein a distance between the image capture region and the in-focus upright image formed by the optical system is greater than or equal to the near point distance.

27. A kit for an iris imaging apparatus for acquiring an image of a subject's iris, comprising:
an iris camera comprising an image sensor, and configured to have an image capture region defining an intended position of the subject's iris during image capture; and
an optical system comprising a reflective element, the reflective element configured for disposition such that, responsive to positioning of the subject's iris within the image capture region, the optical system forms a subject viewable in-focus upright image of the subject's iris;
wherein an distance between the intended position of the subject's iris during image capture and an intended position of the reflective element is less than half a near point distance, the near point distance defining a shortest distance from an eye at which an object is capable of in-focus viewing by the eye, and
wherein a distance between the intended position of the subject's iris during image capture and an intended position of the in-focus upright image formed by the optical system is greater than or equal to the near point distance.
